(19) United States
(12) Patent Application Publication
(10) Pub. No.: US 2025/0234227 A1
(43) Pub. Date: Jul. 17, 2025

(54) ADDITIONAL PATH INFORMATION IN MEASUREMENT REPORT FOR AMBIENT DEVICE SENSING

(71) Applicant: QUALCOMM Incorporated, San Diego, CA (US)

(72) Inventors: Mohammad Tarek FAHIM, San Diego, CA (US); Srinivas YERRAMALLI, San Diego, CA (US); Jing SUN, San Diego, CA (US)

(21) Appl. No.: 18/410,880

(22) Filed: Jan. 11, 2024

(51) Int. Cl. H04W 24/10; H04B 17/364

(52) U.S. Cl. CPC H04W 24/10; H04B 17/364

(57) ABSTRACT

Disclosed are techniques for wireless communication. In an aspect, a wireless communication device may transmit a first reference signal. The wireless communication device may receive a second reference signal that is in response to the first reference signal, the first reference signal and the second reference signal having a same operating frequency. The wireless communication device may determine a first channel impulse response based on the first reference signal and the second reference signal. The wireless communication device may generate a measurement report for output, the measurement report including a reported channel impulse response that is based on the first channel impulse response and indicates multiple propagation paths observable from the second reference signal.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a wireless communication device includes transmitting a first reference signal; receiving a second reference signal that is in response to the first reference signal, the first reference signal and the second reference signal having a same operating frequency; determining a first channel impulse response based on the first reference signal and the second reference signal; and generating a measurement report for output, the measurement report including a reported channel impulse response that is based on the first channel impulse response and indicates multiple propagation paths observable from the second reference signal.

In an aspect, a wireless communication device includes one or more memories; one or more transceivers; and one or more processors communicatively coupled to the one or more memories and the one or more transceivers, the one or more processors, either alone or in combination, configured to: transmit, via the one or more transceivers, a first reference signal; receive, via the one or more transceivers, a second reference signal that is in response to the first reference signal, the first reference signal and the second reference signal having a same operating frequency; determine a first channel impulse response based on the first reference signal and the second reference signal; and generate a measurement report for output, the measurement report including a reported channel impulse response that is based on the first channel impulse response and indicates multiple propagation paths observable from the second reference signal.

In an aspect, a wireless communication device includes means for transmitting a first reference signal; means for receiving a second reference signal that is in response to the first reference signal, the first reference signal and the second reference signal having a same operating frequency; means for determining a first channel impulse response based on the first reference signal and the second reference signal; and means for generating a measurement report for output, the measurement report including a reported channel impulse response that is based on the first channel impulse response and indicates multiple propagation paths observable from the second reference signal.

In an aspect, a non-transitory computer-readable medium stores computer-executable instructions that, when executed by a wireless communication device, cause the wireless communication device to: transmit a first reference signal; receive a second reference signal that is in response to the first reference signal, the first reference signal and the second reference signal having a same operating frequency; determine a first channel impulse response based on the first reference signal and the second reference signal; and generate a measurement report for output, the measurement report including a reported channel impulse response that is based on the first channel impulse response and indicates multiple propagation paths observable from the second reference signal.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIG. 3 illustrates an example ambient application, according to aspects of the disclosure.

FIGS. 4A, 4B, and 4C are simplified block diagrams of several sample aspects of components that may be employed in a user equipment (UE), a base station, and a network entity, respectively, and configured to support communications as taught herein.

FIG. 5 illustrates a simplified block diagram of an ambient station and an ambient device in an ambient system (e.g., an ambient internet of things (IoT) system), according to aspects of the disclosure.

FIG. 6 is a diagram illustrating an example frame structure, according to aspects of the disclosure.

FIG. 7 illustrates an example ambient system (e.g., an ambient IoT system) for a backscatter-based positioning procedure, according to aspects of the disclosure.

FIG. 8 is a graph representing a radio frequency (RF) channel impulse response over time, according to aspects of the disclosure.

FIGS. 9A-9D illustrate four example connectivity topologies for ambient networks and devices, according to aspects of the disclosure.

FIG. 10A illustrates an example scenario for an ambient device, according to aspects of the disclosure.

FIG. 10B illustrates a one-way channel impulse response (CIR) and a round-trip CIR corresponding to one or more propagation paths between an ambient station and an ambient device, according to aspects of the disclosure.

FIG. 11 is a procedure flow diagram showing example flows of providing a measurement report that include a reported channel impulse response, according to aspects of the disclosure.

FIG. 12 is a flowchart illustrating a method of operating a wireless communication device, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to wireless communications. Some aspects more specifically relate to including additional path information in a measurement report for sensing ambient devices such as an ambient internet of things (IoT) device. In some examples, a wireless communication device (e.g., a reader device) may transmit an interrogating signal and receive a backscattered response signal from an ambient device and determine a round-tip channel impulse response (e.g., having N (N+1)/2 taps) accordingly. In some examples, the wireless communication device may further, based on the round-tip channel impulse response, derive and report a one-way channel impulse response (e.g., having N taps).

Particular aspects of the subject matter described in this disclosure can be implemented to realize one or more of the following potential advantages. In some examples, by allowing the wireless device to report the one-way channel impulse response, the described techniques can be used to reduce the reporting overhead for reporting the additional path information regarding a propagation channel between the wireless communication device and the ambient device.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

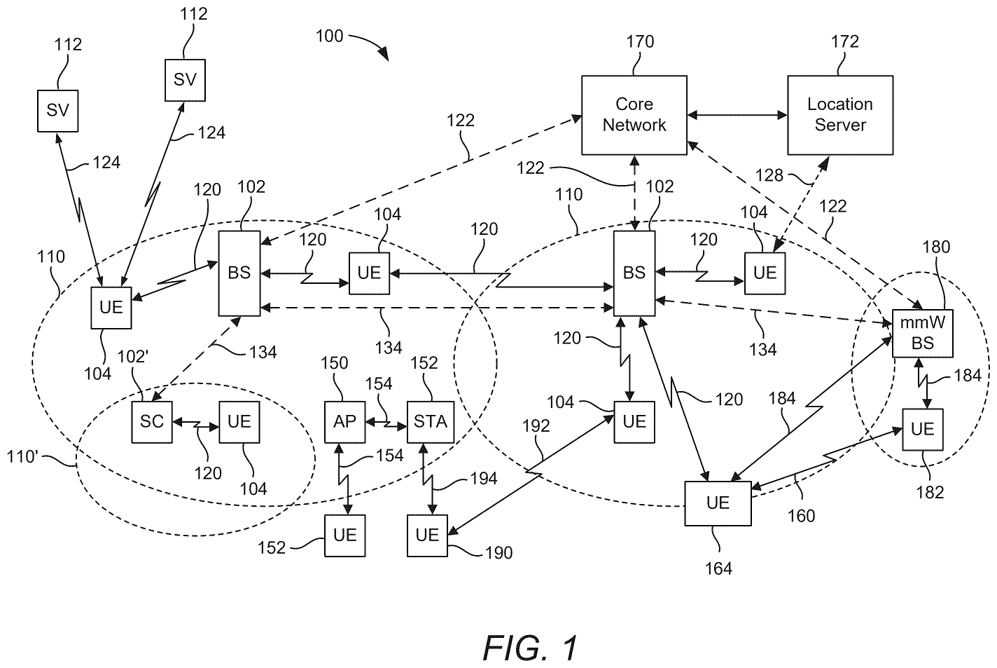

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHZ), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

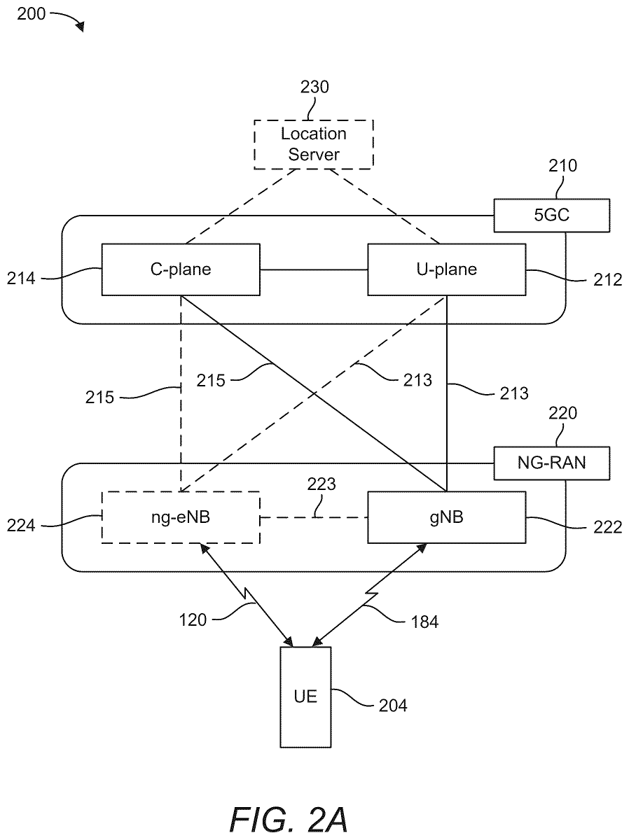

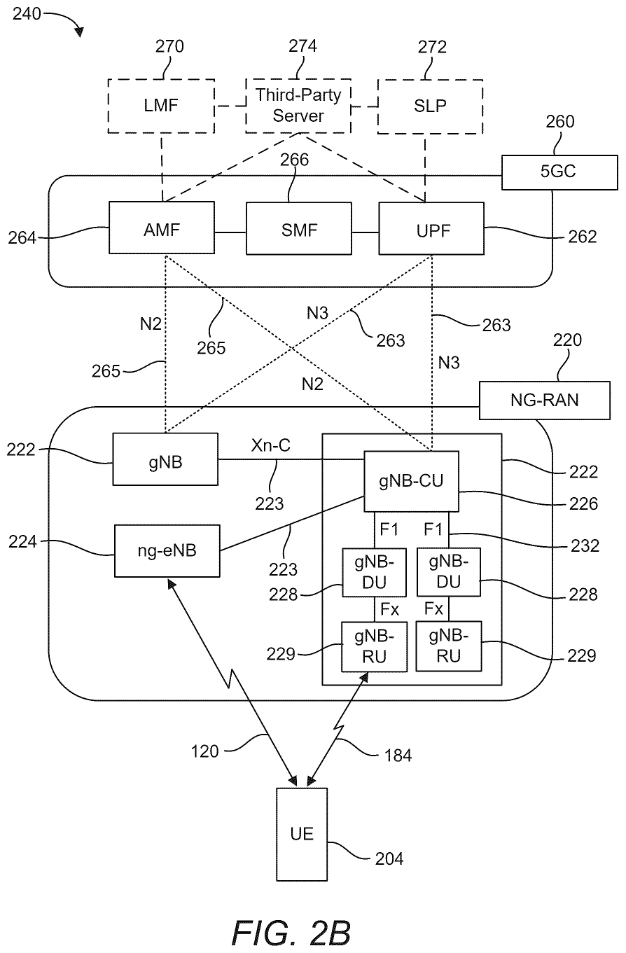

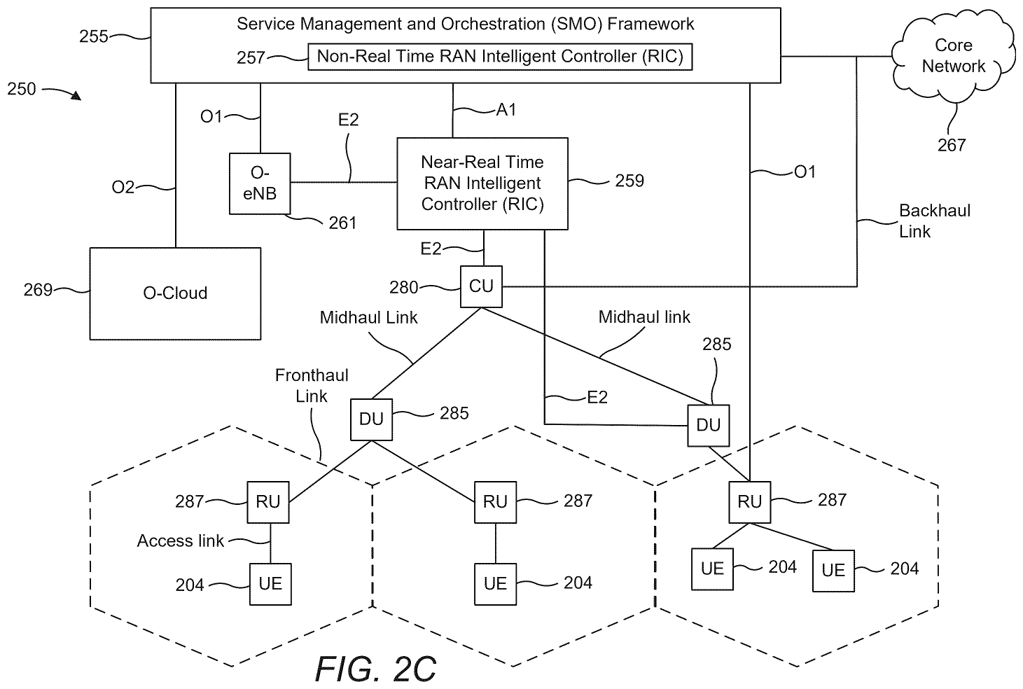

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

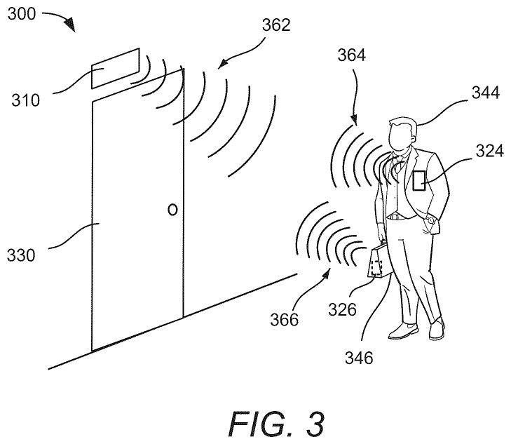

FIG. 3 illustrates an example ambient application, according to aspects of the disclosure. For example, the example ambient application shown in FIG. 3 may correspond to a radio frequency identification (RFID) system 300. In some aspects, the RFID system 300 includes an ambient station 310 configured as an RFID reader and ambient devices 324 and 326 configured as RFID tags. In this example, the ambient station 310 may be for controlling the access to the door 330. In some examples, based on the frequency band of the air interface, the RFID technology may be referred to as Low Frequency (LF) RFID (e.g., from 30 kHz to 300 kHz), High Frequency (HF) RFID (e.g., from 3 MHz to 30 MHz), or Ultra High Frequency (UHF) RFID (e.g., from 300 MHz to 3 GHZ).

As shown in FIG. 3, a person 344 (e.g., an employee) carrying an asset 346 (e.g., a suitcase) may want to access the door 330. The person 344 may carry the ambient device 324 (e.g., embedded in an RFID enabled access card), and the asset 346 may have the ambient device 326 (e.g., an RFID asset tag) attached thereon. To identify the person 344 or the asset 346 in order to grant or deny the access to the door 330, the ambient station 310 may transmit an interrogating signal 362. In response to the interrogating signal 362, the ambient device 324 may transmit a backscattered response signal 364, and the ambient device 326 may transmit a backscattered response signal 366. The backscattered response signal 364 may be modulated with data stored in and/or generated by the ambient device 324 in response to a command encoded in the interrogating signal 362. Also, the backscattered response signal 366 may be modulated with data stored in and/or generated by the ambient device 326 in response to the command encoded in the interrogating signal 362. The ambient station 310 may receive and decode the backscattered response signals 364 and 366 in order to obtain the response provided by the ambient devices 324 and 326.

FIG. 3 shows a possible application of an ambient application. In some aspects, applications of the ambient technology may have applications in, for example, automated checkout, monitoring medication intakes for elderlies, vehicle ignition keys, employee attendance system, positioning objects, or tracking objects. In some aspects, the ambient devices may be attached to, embedded in, or integrally formed with a target or an object, including a wireless communications device, a shipping container, a merchandise, an identification card, a payment card, an automobile, or a pet.

In some aspects, the ambient station 310 may be configured to communicate with the ambient devices 324 and 326 over an air interface based on one or more ambient communications standards or wireless communications standards, such as those set by the International Organization for Standardization (ISO), the International Electrotechnical Commission (IEC), American Society for Testing and Materials (ASTM) International, the DASH7 Alliance, Electronic Product Code Global (EPCglobal), and/or 3GPP standards for Ambient IoT.

In some aspects, an ambient system may be implemented integrally or in parallel with a wireless communications system (e.g., the LTE or 5G NR as described above), and the ambient interrogating signals may be transmitted over a radio resource of the wireless communications system.

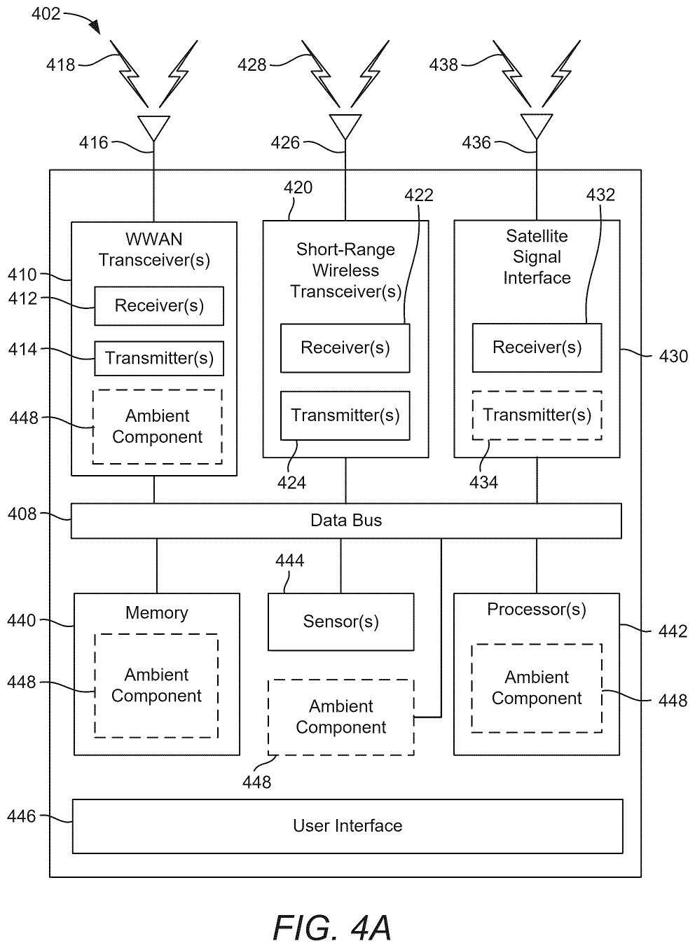

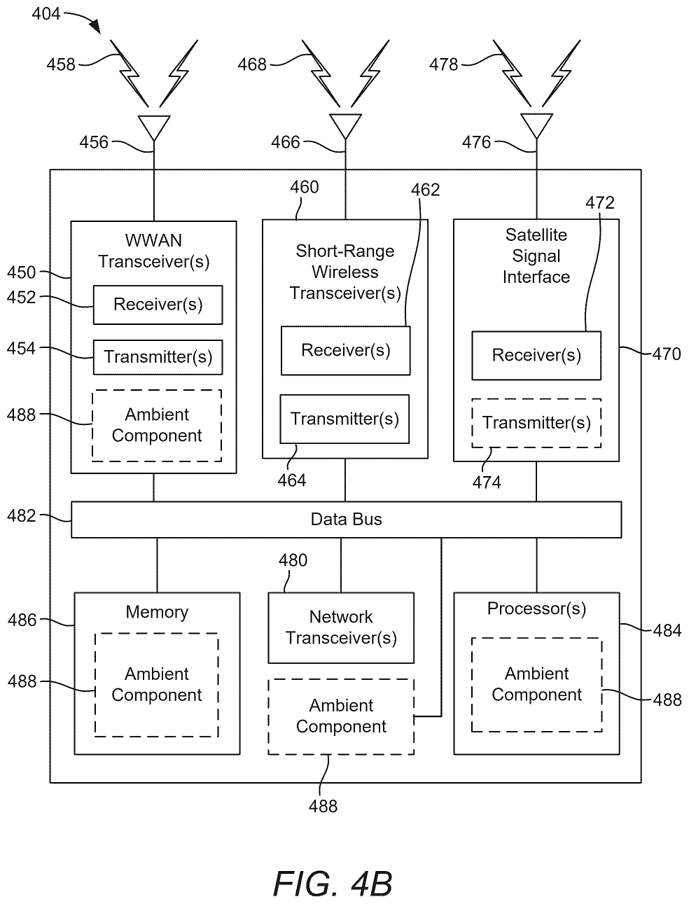

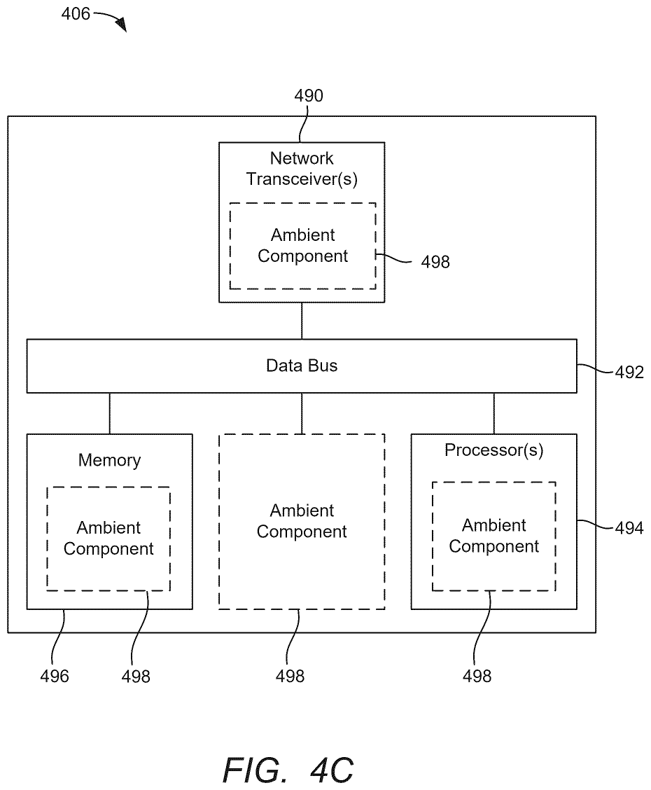

FIGS. 4A, 4B, and 4C illustrate several example components (represented by corresponding blocks) that may be incorporated into a UE 402 (which may correspond to any of the UEs described herein), a base station 404 (which may correspond to any of the base stations described herein), and a network entity 406 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 402 and the base station 404 each include one or more wireless wide area network (WWAN) transceivers 410 and 450, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 410 and 450 may each be connected to one or more antennas 416 and 456, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 410 and 450 may be variously configured for transmitting and encoding signals 418 and 458 (e.g., messages, indications, information, and so on), respectively, and, conversely, for receiving and decoding signals 418 and 458 (e.g., messages, indications, information, pilots, and so on), respectively, in accordance with the designated RAT. Specifically, the WWAN transceivers 410 and 450 include one or more transmitters 414 and 454, respectively, for transmitting and encoding signals 418 and 458, respectively, and one or more receivers 412 and 452, respectively, for receiving and decoding signals 418 and 458, respectively.

The UE 402 and the base station 404 each also include, at least in some cases, one or more short-range wireless transceivers 420 and 460, respectively. The short-range wireless transceivers 420 and 460 may be connected to one or more antennas 426 and 466, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 420 and 460 may be variously configured for transmitting and encoding signals 428 and 468 (e.g., messages, indications, information, and so on), respectively, and, conversely, for receiving and decoding signals 428 and 468 (e.g., messages, indications, information, pilots, and so on), respectively, in accordance with the designated RAT. Specifically, the short-range wireless transceivers 420 and 460 include one or more transmitters 424 and 464, respectively, for transmitting and encoding signals 428 and 468, respectively, and one or more receivers 422 and 462, respectively, for receiving and decoding signals 428 and 468, respectively. As specific examples, the short-range wireless transceivers 420 and 460 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 402 and the base station 404 also include, at least in some cases, satellite signal interfaces 430 and 470, which each include one or more satellite signal receivers 432 and 472, respectively, and may optionally include one or more satellite signal transmitters 434 and 474, respectively. In some cases, the base station 404 may be a terrestrial base station that may communicate with space vehicles (e.g., space vehicles 112) via the satellite signal interface 470. In other cases, the base station 404 may be a space vehicle (or other non-terrestrial entity) that uses the satellite signal interface 470 to communicate with terrestrial networks and/or other space vehicles.

The satellite signal receivers 432 and 472 may be connected to one or more antennas 436 and 476, respectively, and may provide means for receiving and/or measuring satellite positioning/communication signals 438 and 478, respectively. Where the satellite signal receiver(s) 432 and 472 are satellite positioning system receivers, the satellite positioning/communication signals 438 and 478 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 432 and 472 are non-terrestrial network (NTN) receivers, the satellite positioning/communication signals 438 and 478 may be communication signals (e.g., carrying control and/or user data) originating from a 5G network. The satellite signal receiver(s) 432 and 472 may comprise any suitable hardware and/or software for receiving and processing satellite positioning/communication signals 438 and 478, respectively. The satellite signal receiver(s) 432 and 472 may request information and operations as appropriate from the other systems, and, at least in some cases, perform calculations to determine locations of the UE 402 and the base station 404, respectively, using measurements obtained by any suitable satellite positioning system algorithm.

The optional satellite signal transmitter(s) 434 and 474, when present, may be connected to the one or more antennas 436 and 476, respectively, and may provide means for transmitting satellite positioning/communication signals 438 and 478, respectively. Where the satellite signal transmitter(s) 474 are satellite positioning system transmitters, the satellite positioning/communication signals 478 may be GPS signals, GLONASS® signals, Galileo signals, Beidou signals, NAVIC, QZSS signals, etc. Where the satellite signal transmitter(s) 434 and 474 are NTN transmitters, the satellite positioning/communication signals 438 and 478 may be communication signals (e.g., carrying control and/or user data) originating from a 5G network. The satellite signal transmitter(s) 434 and 474 may comprise any suitable hardware and/or software for transmitting satellite positioning/communication signals 438 and 478, respectively. The satellite signal transmitter(s) 434 and 474 may request information and operations as appropriate from the other systems.

The base station 404 and the network entity 406 each include one or more network transceivers 480 and 490, respectively, providing means for communicating (e.g., means for transmitting, means for receiving, etc.) with other network entities (e.g., other base stations 404, other network entities 406). For example, the base station 404 may employ the one or more network transceivers 480 to communicate with other base stations 404 or network entities 406 over one or more wired or wireless backhaul links. As another example, the network entity 406 may employ the one or more network transceivers 490 to communicate with one or more base station 404 over one or more wired or wireless backhaul links, or with other network entities 406 over one or more wired or wireless core network interfaces.

A transceiver may be configured to communicate over a wired or wireless link. A transceiver (whether a wired transceiver or a wireless transceiver) includes transmitter circuitry (e.g., transmitters 414, 424, 454, 464) and receiver circuitry (e.g., receivers 412, 422, 452, 462). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 480 and 490 in some implementations) may be coupled to one or more wired network interface ports. Wireless transmitter circuitry (e.g., transmitters 414, 424, 454, 464) may include or be coupled to a plurality of antennas (e.g., antennas 416, 426, 456, 466), such as an antenna array, that permits the respective apparatus (e.g., UE 402, base station 404) to perform transmit “beamforming,” as described herein. Similarly, wireless receiver circuitry (e.g., receivers 412, 422, 452, 462) may include or be coupled to a plurality of antennas (e.g., antennas 416, 426, 456, 466), such as an antenna array, that permits the respective apparatus (e.g., UE 402, base station 404) to perform receive beamforming, as described herein. In an aspect, the transmitter circuitry and receiver circuitry may share the same plurality of antennas (e.g., antennas 416, 426, 456, 466), such that the respective apparatus can only receive or transmit at a given time, not both at the same time. A wireless transceiver (e.g., WWAN transceivers 410 and 450, short-range wireless transceivers 420 and 460) may also include a network listen module (NLM) or the like for performing various measurements.

As used herein, the various wireless transceivers (e.g., transceivers 410, 420, 450, and 460, and network transceivers 480 and 490 in some implementations) and wired transceivers (e.g., network transceivers 480 and 490 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 402) and a base station (e.g., base station 404) will generally relate to signaling via a wireless transceiver.

The UE 402, the base station 404, and the network entity 406 also include other components that may be used in conjunction with the operations as disclosed herein. The UE 402, the base station 404, and the network entity 406 include one or more processors 442, 484, and 494, respectively, for providing functionality relating to, for example, wireless communication, and for providing other processing functionality. The processors 442, 484, and 494 may therefore provide means for processing, such as means for determining, means for calculating, means for receiving, means for transmitting, means for indicating, etc. In an aspect, the processors 442, 484, and 494 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 402, the base station 404, and the network entity 406 include memory circuitry implementing memories 440, 486, and 496 (e.g., each including a memory device), respectively, for maintaining information (e.g., information indicative of reserved resources, thresholds, parameters, and so on). The memories 440, 486, and 496 may therefore provide means for storing, means for retrieving, means for maintaining, etc. In some cases, the UE 402, the base station 404, and the network entity 406 may include ambient component 448, 488, and 498, respectively. The ambient component 448, 488, and 498 may be hardware circuits that are part of or coupled to the processors 442, 484, and 494, respectively, that, when executed, cause the UE 402, the base station 404, and the network entity 406 to perform the functionality described herein. In other aspects, the ambient component 448, 488, and 498 may be external to the processors 442, 484, and 494 (e.g., part of a modem processing system, integrated with another processing system, etc.). Alternatively, the ambient component 448, 488, and 498 may be memory modules stored in the memories 440, 486, and 496, respectively, that, when executed by the processors 442, 484, and 494 (or a modem processing system, another processing system, etc.), cause the UE 402, the base station 404, and the network entity 406 to perform the functionality described herein. FIG. 4A illustrates possible locations of the ambient component 448, which may be, for example, part of the one or more WWAN transceivers 410, the memory 440, the one or more processors 442, or any combination thereof, or may be a standalone component. FIG. 4B illustrates possible locations of the ambient component 488, which may be, for example, part of the one or more WWAN transceivers 450, the memory 486, the one or more processors 484, or any combination thereof, or may be a standalone component. FIG. 4C illustrates possible locations of the ambient component 498, which may be, for example, part of the one or more network transceivers 490, the memory 496, the one or more processors 494, or any combination thereof, or may be a standalone component.

The UE 402 may include one or more sensors 444 coupled to the one or more processors 442 to provide means for sensing or detecting movement and/or orientation information that is independent of motion data derived from signals received by the one or more WWAN transceivers 410, the one or more short-range wireless transceivers 420, and/or the satellite signal interface 430. By way of example, the sensor(s) 444 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 444 may include a plurality of different types of devices and combine their outputs in order to provide motion information. For example, the sensor(s) 444 may use a combination of a multi-axis accelerometer and orientation sensors to provide the ability to compute positions in two-dimensional (2D) and/or three-dimensional (3D) coordinate systems.

In addition, the UE 402 includes a user interface 446 providing means for providing indications (e.g., audible and/or visual indications) to a user and/or for receiving user input (e.g., upon user actuation of a sensing device such a keypad, a touch screen, a microphone, and so on). Although not shown, the base station 404 and the network entity 406 may also include user interfaces.

Referring to the one or more processors 484 in more detail, in the downlink, IP packets from the network entity 406 may be provided to the processor 484. The one or more processors 484 may implement functionality for an RRC layer, a packet data convergence protocol (PDCP) layer, a radio link control (RLC) layer, and a medium access control (MAC) layer. The one or more processors 484 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 454 and the receiver 452 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 454 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 402. Each spatial stream may then be provided to one or more different antennas 456. The transmitter 454 may modulate an RF carrier with a respective spatial stream for transmission.

At the UE 402, the receiver 412 receives a signal through its respective antenna(s) 416. The receiver 412 recovers information modulated onto an RF carrier and provides the information to the one or more processors 442. The transmitter 414 and the receiver 412 implement Layer-1 functionality associated with various signal processing functions. The receiver 412 may perform spatial processing on the information to recover any spatial streams destined for the UE 402. If multiple spatial streams are destined for the UE 402, they may be combined by the receiver 412 into a single OFDM symbol stream. The receiver 412 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 404. These soft decisions may be based on channel estimates computed by a channel estimator. The soft decisions are then decoded and de-interleaved to recover the data and control signals that were originally transmitted by the base station 404 on the physical channel. The data and control signals are then provided to the one or more processors 442, which implements Layer-3 (L3) and Layer-2 (L2) functionality.

In the downlink, the one or more processors 442 provides demultiplexing between transport and logical channels, packet reassembly, deciphering, header decompression, and control signal processing to recover IP packets from the core network. The one or more processors 442 are also responsible for error detection.

Similar to the functionality described in connection with the downlink transmission by the base station 404, the one or more processors 442 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 404 may be used by the transmitter 414 to select the appropriate coding and modulation schemes, and to facilitate spatial processing. The spatial streams generated by the transmitter 414 may be provided to different antenna(s) 416. The transmitter 414 may modulate an RF carrier with a respective spatial stream for transmission.

The uplink transmission is processed at the base station 404 in a manner similar to that described in connection with the receiver function at the UE 402. The receiver 452 receives a signal through its respective antenna(s) 456. The receiver 452 recovers information modulated onto an RF carrier and provides the information to the one or more processors 484.

In the uplink, the one or more processors 484 provides demultiplexing between transport and logical channels, packet reassembly, deciphering, header decompression, control signal processing to recover IP packets from the UE 402. IP packets from the one or more processors 484 may be provided to the core network. The one or more processors 484 are also responsible for error detection.

For convenience, the UE 402, the base station 404, and/or the network entity 406 are shown in FIGS. 4A, 4B, and 4C as including various components that may be configured according to the various examples described herein. It will be appreciated, however, that the illustrated components may have different functionality in different designs. In particular, various components in FIGS. 4A to 4C are optional in alternative configurations and the various aspects include configurations that may vary due to design choice, costs, use of the device, or other considerations. For example, in case of FIG. 4A, a particular implementation of UE 402 may omit the WWAN transceiver(s) 410 (e.g., a wearable device or tablet computer or personal computer (PC) or laptop may have Wi-Fi and/or BLUETOOTH® capability without cellular capability), or may omit the short-range wireless transceiver(s) 420 (e.g., cellular-only, etc.), or may omit the satellite signal interface 430, or may omit the sensor(s) 444, and so on. In another example, in case of FIG. 4B, a particular implementation of the base station 404 may omit the WWAN transceiver(s) 450 (e.g., a Wi-Fi “hotspot” access point without cellular capability), or may omit the short-range wireless transceiver(s) 460 (e.g., cellular-only, etc.), or may omit the satellite signal interface 470, and so on. For brevity, illustration of the various alternative configurations is not provided herein, but would be readily understandable to one skilled in the art.

The various components of the UE 402, the base station 404, and the network entity 406 may be communicatively coupled to each other over data buses 408, 482, and 492, respectively. In an aspect, the data buses 408, 482, and 492 may form, or be part of, a communication interface of the UE 402, the base station 404, and the network entity 406, respectively. For example, where different logical entities are embodied in the same device (e.g., gNB and location server functionality incorporated into the same base station 404), the data buses 408, 482, and 492 may provide communication between them.

The components of FIGS. 4A, 4B, and 4C may be implemented in various ways. In some implementations, the components of FIGS. 4A, 4B, and 4C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 410 to 446 may be implemented by processor and memory component(s) of the UE 402 (e.g., by execution of appropriate code and/or by appropriate configuration of processor components). Similarly, some or all of the functionality represented by blocks 450 to 488 may be implemented by processor and memory component(s) of the base station 404 (e.g., by execution of appropriate code and/or by appropriate configuration of processor components). Also, some or all of the functionality represented by blocks 490 to 498 may be implemented by processor and memory component(s) of the network entity 406 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 402, base station 404, network entity 406, etc., such as the processors 442, 484, 494, the transceivers 410, 420, 450, and 460, the memories 440, 486, and 496, the ambient component 448, 488, and 498, etc.

In some designs, the network entity 406 may be implemented as a core network component. In other designs, the network entity 406 may be distinct from a network operator or operation of the cellular network infrastructure (e.g., NG RAN 220 and/or 5GC 210/260). For example, the network entity 406 may be a component of a private network that may be configured to communicate with the UE 402 via the base station 404 or independently from the base station 404 (e.g., over a non-cellular communication link, such as Wi-Fi).

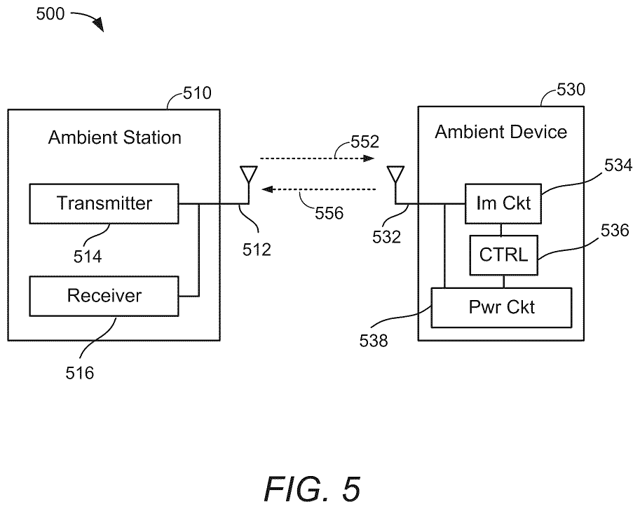

FIG. 5 illustrates a simplified block diagram of an ambient station 510 and an ambient device 530 in an ambient system 500 (e.g., an ambient internet of things (IoT) system), according to aspects of the disclosure. In some aspects, the ambient station 510 may be an RFID reader or similar technology and may correspond to the ambient station 310 in FIG. 3. In some aspects, the ambient device 530 may be an RFID tag or similar technology and may correspond to the ambient device 324 or the ambient device 326 in FIG. 3.

As shown in FIG. 5, the ambient station 510 includes an antenna 512, and a transmitter 514 and a receiver 516 electrically coupled with the antenna 512. Also, the ambient device 530 includes an antenna 532, antenna impedance adjusting circuitry 534 (abbreviated as “Im Ckt” in FIG. 5) configured to adjust an impedance of the antenna 532, a controller 536 (abbreviated as “CTRL” in FIG. 5) configured to control the antenna impedance adjusting circuitry 534, and power circuitry 538 (abbreviated as “Pwr Ckt” in FIG. 5) configured to provide the electrical power to the controller 536 and the antenna impedance adjusting circuitry 534.

In some aspects, a TRP in a wireless communications system may be configured to function as, or to incorporate, the ambient station 510. In such scenario, the ambient station 510 may correspond to the base station 404, the transmitter 514 may correspond to the transmitter 454 and/or the ambient component 488 in the WWAN transceivers 450, or the transmitter 464 in the short-range wireless transceivers 460; the receiver 516 may correspond to the receiver 452 and/or the ambient component 488 in the WWAN transceivers 450, or the receiver 462 in the short-range wireless transceivers 460; and the antenna 512 may correspond to the antenna 456 or the antenna 466. In some aspects, a UE in a wireless communications system may be configured to function as, or to incorporate, the ambient station 510. In such scenario, the ambient station 510 may correspond to the UE 402, the transmitter 514 may correspond to the transmitter 414 and/or the ambient component 448 in the WWAN transceivers 420, or the transmitter 424 in the short-range wireless transceivers 420; the receiver 516 may correspond to the receiver 412 and/or the ambient component 448 in the WWAN transceivers 420, or the receiver 422 in the short-range wireless transceivers 420; and the antenna 512 may correspond to the antenna 416 or the antenna 426.

In some aspects, a UE in a wireless communications system may be configured to function as, or to incorporate, the ambient device 530. In such scenario, the ambient device 530 may correspond to the UE 402, the antenna impedance adjusting circuitry 534, the controller 536, and the power circuitry 538 may correspond to the ambient component 448, and the antenna 532 may correspond to the antenna 416 or the antenna 426.

In some aspects, in operation, the transmitter 514 of the ambient station 510 may transmit an interrogating signal 552 via the antenna 512 to the ambient device 530. In some aspects, the interrogating signal 552 may be embedded with a command from the ambient station 510. The command may provide the ambient device 530 a time frame for responding to the interrogating signal 552, instruct the ambient device 530 to provide its identification code or other information related to the identity or capability of the ambient device 530, or both. The ambient device 530, when being powered on and upon receiving the interrogating signal 552, may cause the controller 536 to prepare a response based on the embedded command and to control the antenna impedance adjusting circuitry 534 to adjust an impedance of the antenna 532 based on the prepared response. The antenna 532 may reflect the interrogating signal 552 based on the impedance of the antenna 532, and the reflected signal may also be referred to as a backscattered response signal 556. As the impedance of the antenna 532 varies, the amplitude, phase, and/or frequency of the backscattered response signal 556 may vary. Accordingly, the controller 536 may modulate the backscattered response signal 556 to carry the response by adjusting the impedance of the antenna 532.

In some aspects, the ambient device 530 may be a passive ambient device. In such scenario, the power circuitry 538 may harvest the electrical power from the interrogating signal 552 to power the controller 536 and the antenna impedance adjusting circuitry 534. In some aspects, the ambient device 530 may be a semi-passive ambient device. In such scenario, the power circuitry 538 may power the controller 536 and the antenna impedance adjusting circuitry 534 based on the harvested power from the interrogating signal 552 or an on-board battery (not shown) of the ambient device 530. Also, in some examples, the power circuitry 538 may perform the energy harvesting functionality for detecting the presence or absence of the interrogating signal 552.

Moreover, the receiver 516 of the ambient station 510 may receive the backscattered response signal 556 from the ambient device 530 via the antenna 512. The ambient station 510 may decode the backscattered response signal 556 to obtain the response provided by the ambient device 530. In some aspects, the ambient system 500 may be used to measure a range or estimate a position of the ambient device 530. In such application, the ambient station 510 may also measure a time of arrival (ToA) of the backscattered response signal 556 as observed at the ambient station 510.

In some aspects, the ambient station 510 may transmit the interrogating signal 552 and receive the backscattered response signal 556 in a full-duplex (FDX) mode. In some aspects, the ambient station 510 may transmit the interrogating signal 552 and receive the backscattered response signal 556 in a half-duplex (HDX) mode. In some aspects, for operations based on backscattering, the ambient station 510 may continue transmitting the interrogating signal 552 in the FDX mode or in the HDX mode regardless of the interrogating signal 552 indeed carrying an embedded command/message or not (e.g., continuing transmitting a carrier wave of the interrogating signal 552 without being modulated to carry any embedded command/message).

In some aspects, as the ambient system 500 may be implemented integrally or in parallel with a wireless communications system (e.g., the LTE or 5G NR as described above), the RFID interrogating signal 552 may be transmitted over a radio resource of the wireless communications system. In some aspects, the ambient system 500 may be used to perform a positioning procedure of the ambient device 530 based on the backscattered response signal from the ambient device 530 (also referred to as a backscatter-based positioning procedure), where the ambient system 500 may transmit a positioning reference signal as an interrogating signal, or transmit the interrogating signal over a radio resource of the positioning reference signal of a wireless communications system. In some examples, the positioning reference signal (or the corresponding radio resources) may be a downlink positioning reference signal (DL-PRS), a sidelink positioning reference signal (SL-PRS), or a sounding reference signal (SRS) (or the corresponding radio resources).

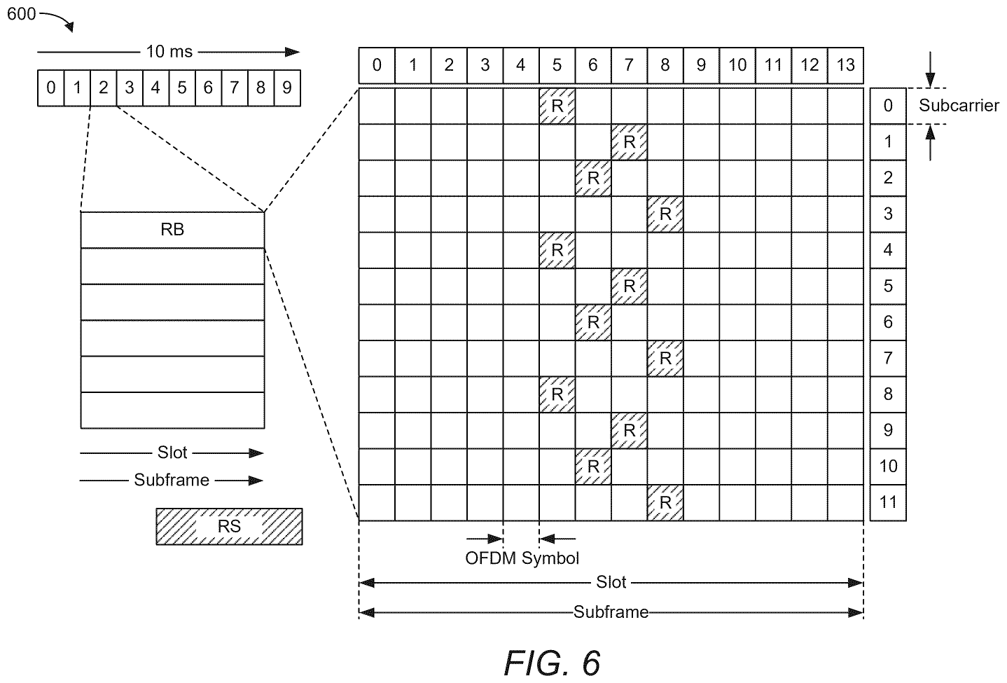

Various frame structures may be used to support downlink and uplink transmissions between network nodes (e.g., base stations and UEs). FIG. 6 is a diagram 600 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHZ, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 6, a numerology of 15 kHz is used. Thus, in the time domain, a 10 ms frame is divided into 10 equally sized subframes of 1 ms each, and each subframe includes one time slot. In FIG. 6, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 6, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 6 illustrates example locations of REs carrying a reference signal (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 6 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3} (as in the example of FIG. 6); 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

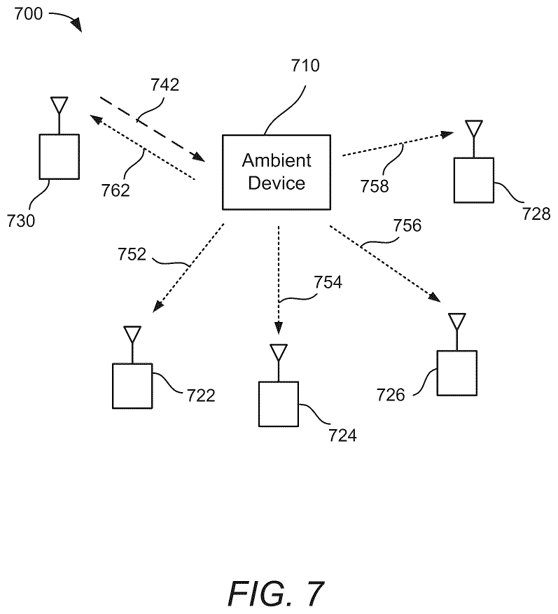

FIG. 7 illustrates an example ambient system 700 (e.g., an ambient IoT system) for a backscatter-based positioning procedure, according to aspects of the disclosure. The ambient system 700 includes an ambient device 710, and a position of which is to be determined based on the backscatter-based positioning procedure. The ambient system 700 includes one or more receiving ambient stations 722, 724, 726, and 728. The ambient system 700 further includes a transmitting ambient station 730. In some examples, the ambient station 730 may also be configured as a receiving ambient station. In some aspects, the ambient system 700 may include one or more transmitting ambient stations.

In some aspects, the ambient device 710 may be a standalone ambient device, or may be a device configured to function as an ambient device. In some aspect, the ambient device 710 may correspond to the ambient devices described in FIG. 3 or FIG. 5. In some aspects, the ambient stations 722, 724, 726, 728, and 730 may correspond to the ambient stations described in FIG. 3 or FIG. 5. In some aspects, each one of the ambient stations 722, 724, 726, 728, and 730 may be a UE (such as any UE described above) or a TRP (such as any TRP or base station described above) of a wireless communications network.

In some aspects, to perform the backscatter-based positioning procedure, the ambient station 730 may transmit an interrogating signal 742 (e.g., a carrier wave with or without being modulated to carry an embedded command or message) to the ambient device 710.

In some aspects, the interrogating signal 742 may be a positioning reference signal of the wireless communications network, such as DL-PRS, SL-PRS, or SRS. In response to the interrogating signal 742, the ambient device 710 may transmit a backscattered response signal by reflecting (also referred to as backscattering in this disclosure) the interrogating signal 742. The backscattered response signal may be observed at the ambient stations 722, 724, 726, 728, and 730 and labeled in FIG. 7 as respective received backscattered response signals 752, 754, 756, 758, and 762.

In some aspects, the ambient stations 722, 724, 726, 728, and 730 may record the time points the received backscattered response signals 752, 754, 756, 758, and 762 arrive. Based on the measured reception time points and the time of transmission of the interrogating signal 742 at the ambient station 730, the combined propagation time of the interrogating signal 742 and the received backscattered response signals 752, 754, 756, 758, and 762, denoted as τ₁, τ₂, τ₃, τ₄, and τ₀, may satisfy the following expressions:

$${τ}_{1} = {τ}_{tx - TAG} + {τ}_{TAG - rx 1} ,$$

$${τ}_{2} = {τ}_{tx - TAG} + {τ}_{TAG - rx 2} ,$$

$${τ}_{3} = {τ}_{tx - TAG} + {τ}_{TAG - rx 3} ,$$

$${τ}_{4} = {τ}_{tx - TAG} + {τ}_{TAG - rx 4} ,$$

$${τ}_{0} = {τ}_{tx - TAG} + {τ}_{TAG - rx 0} , and$$

$${τ}_{tx - TAG} + {τ}_{TAG - rx 0} .$$

τ_{tx-TAG} represents the propagation time from the transmitting ambient station 730 to the ambient device 710. τ_{TAG-rx0} represents the propagation time from the ambient device 710 to the transmitting ambient station 730. τ_{TAG-rx1} represents the propagation time from the ambient device 710 to the receiving ambient station 722. τ_{TAG-rx2} represents the propagation time from the ambient device 710 to the receiving ambient station 724. τ_{TAG-rx3} represents the propagation time from the ambient device 710 to the receiving ambient station 726. τ_{TAG-rx4} represents the propagation time from the ambient device 710 to the receiving ambient station 728.

In some aspects, based on τ₁, τ₂, τ₃, τ₄, and τ₀, an estimated position of the ambient device 710 may be determined based on a Time-of-Arrival (ToA) positioning method. In some examples, the time-of-arrival values may correspond to the propagation time values from the ambient device 710 to the respective ambient stations 722, 724, 726, 728, and 730 may have the relationship of:

$${τ}_{TAG - rx 0} = \frac{{τ}_{0}}{2} , {τ}_{TAG - rx 1} = {τ}_{1} - \frac{{τ}_{0}}{2} , {τ}_{TAG - rx 2} = {τ}_{2} - \frac{{τ}_{0}}{2} ,$$

$${τ}_{TAG - rx 3} = {τ}_{3} - \frac{{τ}_{0}}{2} , {τ}_{TAG - rx 4} = {τ}_{4} - \frac{{τ}_{0}}{2} .$$

The estimated ranges between the ambient device 710 and the respective ambient stations 722, 724, 726, 728, and 730 may be calculated by multiplying the time-of-arrival values by the speed of the RF waves (e.g., the speed of light). Moreover, based on the estimated ranges and the position information of the ambient stations 722, 724, 726, 728, and 730, the estimated position of the ambient device may be derived.

In some aspects, based on τ₁, τ₂, τ₃, τ₄, and τ₀, an estimated position of the ambient device 710 may be determined based on a Time Difference of Arrival (TDOA) positioning method. In some examples, the propagation time differences between any two of the ambient stations 722, 724, 726, 728, and 730 may have the expressions of: ∇τ_{i,j}=τ_{TAG-rxi}−τ_{TAG-rxj}=τᵢ−τⱼ, where i an j represents the corresponding two of the ambient stations 722, 724, 726, 728, and 730. The estimated curves that pass through the ambient device 710 may be determined based on the multiplication of propagation time differences and the speed of the RF waves (e.g., the speed of light), and the estimated position of the ambient device 710 may be derived based on cross-sections of the estimated curves.

In some aspects, based on τ₀, an estimated range between the ambient device 710 and the ambient station 730 may also be determined based on a Round Trip Time (RTT) positioning method.

FIG. 7 shows a non-limiting example for a backscatter-based positioning procedure having a transmitting ambient station that also functions as a receiving ambient station, together with four other receiving ambient stations. In some examples for performing a particular backscatter-based positioning procedure, the transmitting ambient station may be configured not to function as a receiving ambient station. Also, in some examples for performing a particular backscatter-based positioning procedure, a number of transmitting or receiving ambient stations may be different from the example shown in FIG. 7.

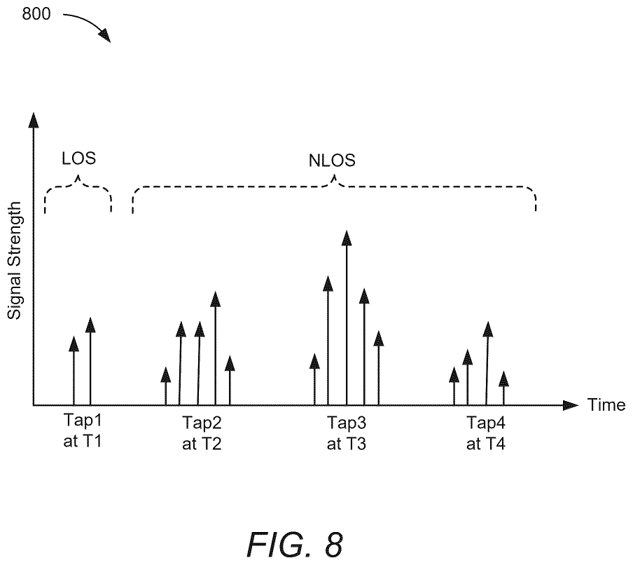

FIG. 8 is a graph 800 representing an example channel estimate of a multipath channel between a receiver device (e.g., any of the UEs or base stations described herein) and a transmitter device (e.g., any other of the UEs or base stations described herein), according to aspects of the disclosure. The channel estimate represents the intensity of a radio frequency (RF) signal (e.g., a positioning reference signal (PRS)) received through a multipath channel as a function of time delay, and may be referred to as the channel energy response (CER), channel impulse response (CIR), or power delay profile (PDP) of the channel. Thus, the horizontal axis represents time (e.g., milliseconds) and the vertical axis represents signal strength (e.g., decibels). Note that a multipath channel is a channel between a transmitter and a receiver over which an RF signal follows multiple paths, or multipaths, due to transmission of the RF signal on multiple beams and/or to the propagation characteristics of the RF signal (e.g., reflection, refraction, etc.).

In the example of FIG. 8, the receiver detects/measures multiple (four) channel taps of the RF signal. Each channel tap is a cluster of one or more rays and corresponds to a multipath that the RF signal followed between the transmitter and the receiver. Thus, a channel tap represents the time of arrival and signal strength of an RF signal over a multipath. There may be multiple channel taps due to the RF signal being transmitted on different transmit beams (and therefore at different angles), or because of the propagation characteristics of RF signals (e.g., potentially following different paths due to reflections), or both. Note that although FIG. 8 illustrates channel taps of two to five rays, as will be appreciated, the channel taps may have more or fewer than the illustrated number of rays.

In the example of FIG. 8, the channel tap detected at time T3 is composed of stronger rays than the channel tap detected at time T1. This may be due to an obstruction on the LOS path between the transmitter and the receiver. Alternatively or additionally, there may be a strong reflector along the NLOS path corresponding to the channel tap detected at time T3.

In view of FIGS. 5, 7, and 8, in some aspects, as a transmitting ambient station may also be configured as a receiving ambient station, such ambient station (e.g., the ambient station 510 or the ambient station 730) may determine from the interrogating signal and the backscattered response signal a channel impulse response corresponding to a combination of a first propagation channel from the ambient station to an ambient device and a second propagation channel from the ambient device to the ambient station. Also, in view of FIG. 8, the ambient (e.g., the ambient station 510 or the ambient station 730) may record and/or report not only the ToA timing corresponding to an estimated LOS path of the backscattered response signal, but also the timing differences of various estimated NLOS paths of the backscattered response signal with respect to the LOS path. In some aspects, the timing differences and/or other attributes of the NLOS paths observable from the backscattered response signal may be reported in a measurement report as additional path information in a form of CIR, PDP, or delay profile (DP).

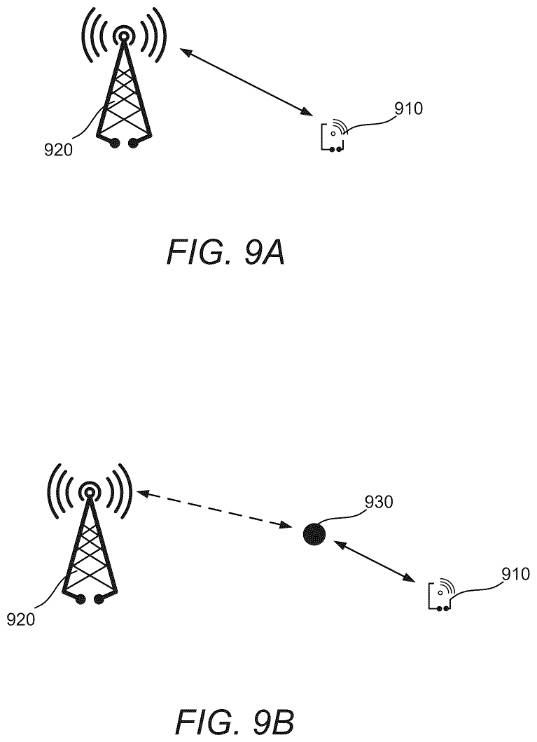

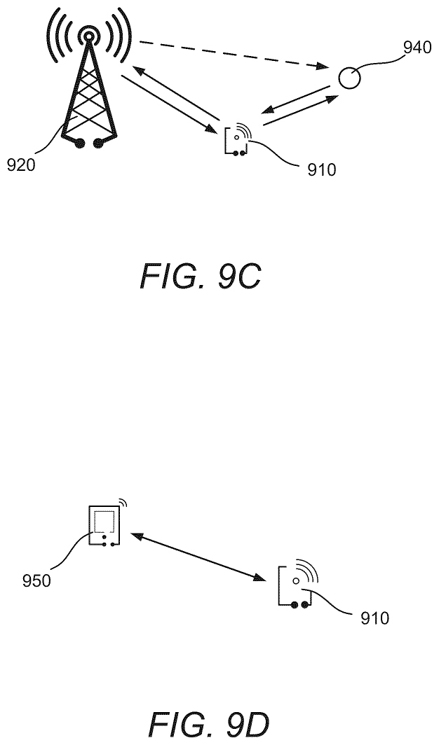

FIGS. 9A-9D illustrate four example connectivity topologies for ambient networks and devices, according to aspects of the disclosure. In some aspects, the ambient device illustrated in FIGS. 9A-9D may be provided with a carrier wave (e.g., with or without being modulated to carry an embedded message) from other node(s) either inside or outside the illustrated example topology. In some aspects, the links in each example topology may be bidirectional or unidirectional. In some aspects, each entity illustrated in FIGS. 9A-9D may represent one or more of the illustrated entity.

As shown in FIG. 9A, an ambient device 910 may directly and bidirectionally communicate with a base station 920 based on ambient communications (e.g., as illustrated in FIGS. 3, 5, and 7 as non-limiting examples). The communication between the base station 920 and the ambient device 910 may include ambient data and/or signaling. In some aspects, the example topology illustrated in FIG. 9A may include the possibility that the illustration of the base station 920 may represent two different base stations, including a transmitting base station for transmitting to the ambient device 910 and a receiving base station for receiving from the ambient device 910.

As shown in FIG. 9B, an ambient device 910 may communicate bidirectionally with an intermediate node 930 based on ambient communications, and the intermediate node 930 may communicate with a base station 920 based on wired communications or wireless communications (e.g., Uu interface). In this example topology, the intermediate node 930 may be a relay, an integrated access and backhaul (IAB) node, a UE (also referred to as an intermediate UE), a repeater, etc., which is capable of ambient communications. In some aspects, the intermediate node 930 may transfer ambient data and/or signaling between the base station 920 and the ambient device 910.

As shown in FIG. 9C, an ambient device 910 may transmit data/signaling to a base station 920 and receive data/signaling from an assisting node 940; or the ambient device 910 may receive data/signaling from the base station 920 and transmit data/signaling to the assisting node 940. In this example topology, the assisting node 940 may be a relay, an IAB node, a UE, a repeater, etc., which is capable ambient communications. In some aspects, the assisting node 940 may communicate with the base station 920 based on wired communications or wireless communications (e.g., Uu interface).

As shown in FIG. 9D, an ambient device 910 may communicate bidirectionally with a UE 950. In some aspects, the communication between the UE 950 and the ambient device 910 may include ambient data and/or signaling.

In some aspects, any of the base station 920 in FIGS. 9A and 9C and the intermediate node 930 in FIG. 9B may record and report ToA information and additional path information of a backscattered response signal from the ambient device 910 in order to collect information for improving the positioning of the ambient device 910 or for artificial intelligent (AI) or machine learning (ML) based positioning analysis (e.g., for ML modeling or as input of the ML model). In some aspects, the additional path information may be reported in a form of CIR, PDP, or delay profile (DP).

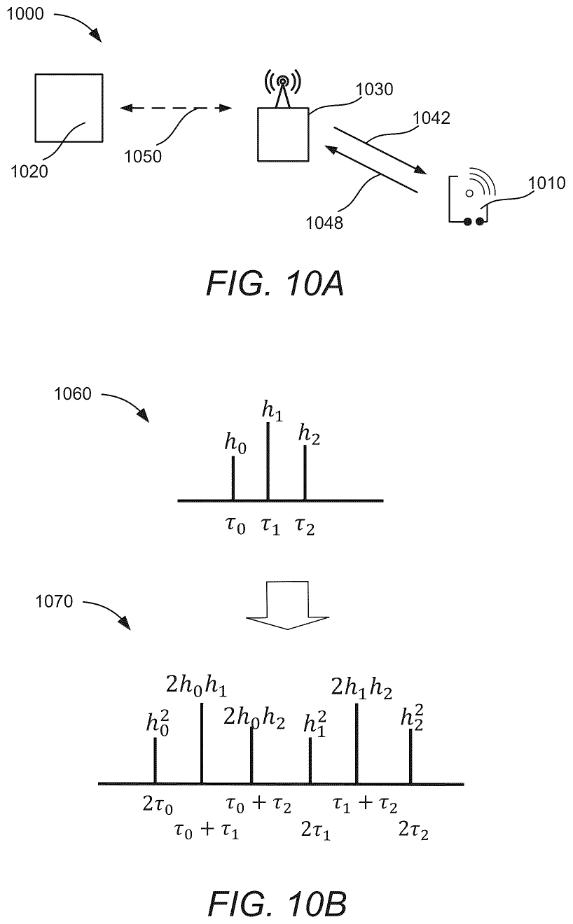

FIG. 10A illustrates an example scenario 1000 for an ambient device 1010, according to aspects of the disclosure. The recording and reporting of the additional paths as observed from a backscattered response signal from an ambient device is explained using the example scenario 1000 as a non-limiting example. In some aspects, the example scenario 1000 includes the ambient device 1010, a managing device 1020, and a reader device 1030. In this example, the reader device 1030 may transmit an interrogating signal (e.g., a first reference signal 1042) and received the backscattered response signal (e.g., a second reference signal 1048) as a monostatic reader. In some aspects, the reader device 1030 and the managing device 1020 may communicate with each other through a communication path 1050, which may be based on wired communications or wireless communications.

In some aspects, the example scenario 1000 may correspond to the connectivity topology shown in FIG. 9B, where the ambient device 1010 may correspond to the ambient device 910, the reader device 1030 may correspond to the intermediate node 930, and the managing device 1020 may correspond to the base station 920 (or a corresponding TRP). In some aspects, the example scenario 1000 may correspond to the connectivity topology shown in FIG. 9A, where the ambient device 1010 may correspond to the ambient device 910, the reader device 1030 may correspond to the base station 920 (or a corresponding TRP), and the managing device 1020 may correspond to a location server that is not depicted in FIG. 9A.

FIG. 10B illustrates a one-way channel impulse response 1060 and a round-trip channel impulse response 1070 corresponding to one or more propagation paths between an ambient station (e.g., the reader device 1030) and an ambient device (e.g., the ambient device 1010), according to aspects of the disclosure. In some aspects, in the scenario 1000, the first reference signal 1042 and the second reference signal 1048 may have a same operating frequency. Accordingly, the channel impulse response corresponding to a first propagation channel from the reader device 1030 to the ambient device 1010 and the channel impulse response corresponding to a second propagation channel from the ambient device 1010 to the reader device 1030 may be the same. In some aspects, the channel impulse responses between the ambient device 1010 to the reader device 1030 may be described as having channel reciprocity when the reference signals 1042 and 1048 have the same operating frequency.

In FIG. 10B, the one-way channel impulse response 1060 may represent either the channel impulse response of the first propagation channel or the channel impulse response of the second propagation channel, without considering any errors and mismatches caused by the reader device 1030 and/or the ambient device 1010 themselves. In this example, the channel impulse response of the first propagation channel from the reader device 1030 to the ambient device 1010 may be called an incident channel impulse response and may be denoted as h_{inc}(t), the channel impulse response of the second propagation channel from the ambient device 1010 to the reader device 1030 may be called a backscatter channel impulse response and may be denoted as h_{bck}(t).

In FIG. 10B, the round-trip channel impulse response 1070 may be the superposition (denoted hₛᵤₚ(t)) of the incident channel impulse response h_{inc}(t) and the backscatter channel impulse response h_{bck}(t). In some aspects, the superposed channel impulse response hₛᵤₚ(t) may be a convolution of the incident channel impulse response h_{inc}(t) and the backscatter channel impulse response h_{bck}(t). That is, hₛᵤₚ(t)=h_{inc}(t)*h_{bck}(t). Also, based on the channel reciprocity, h_{inc}(t)=h_{bck}(t), and hₛᵤₚ(t)=h_{bck}(t)*h_{bck}(t), or hₛᵤₚ(t)=h_{inc}(t)*h_{inc}(t).

In some aspects, the backscatter channel impulse response h_{bck}(t) may have an expression based on summation of multiple taps representing signals based on different paths arrived at different time points. For example, h_{bck}(t) may have an expression of

$${h}_{bck} ( t ) = {\sum }_{i ∈ \{ 0 , … , N - 1 \}} {h}_{i} δ ( t - {τ}_{i} ) ,$$

where N is the number of taps (or also referred to as paths in this disclosure) of h_{bck}(t), hᵢ is the gain (may be a complex number) of the i-th tap, and τᵢ is the time delay of the of the i-th tap. Accordingly, hₛᵤₚ(t) may have an expression of

$${h}_{sup} ( t ) = {\sum }_{i ∈ \{ 0 , … , N - 1 \}} {h}_{i} δ ( t - {τ}_{i} ) * {\sum }_{i ∈ \{ 0 , … , N - 1 \}} {h}_{i} δ ( t - {τ}_{i} ) , and$$

$${h}_{sup} ( t ) = {\sum }_{i , j ∈ \{ 0 , … , N - 1 \}} {h}_{i} {h}_{j} δ ( t - ( {τ}_{i} + {τ}_{j} ) ) .$$

For example, as shown in FIG. 10A, the one-way channel impulse response 1060 may correspond to h_{bck}(t)=h₀δ(t−τ₀)+h₁δ(t−τ₁)+h₂δ(t−τ₂), where the number of taps or paths N is 3. As shown in FIG. 10B, the round-trip channel impulse response 1070 thus may correspond to hₛᵤₚ(t)=h₀²δ(t−2τ₀)+2h₀h₁δ(t−(τ₀+τ₁))+2h₀h₂δ(t−(τ₀+τ₂))+h₁²δ(t−2τ₁)+2h₁h₂δ(t−(τ₁+τ₂))+h₂²δ(t−2τ₂).

In some aspects, as a generalization of the example advanced above, if the backscatter channel impulse response h_{bck}(t) has N taps (or paths), then the superposed channel impulse response hₛᵤₚ(t) may have N(N+1)/2 taps (or paths). In some aspects, while it may be a valid option to report all the N(N+1)/2 taps of the superposed channel impulse response hₛᵤₚ(t) in a measurement report, the N(N+1)/2 taps may indeed include a lot of redundant information that can be further simplified based on the characteristic of channel reciprocity. In some aspects, sending the N taps of a one-way channel impulse response (e.g., the incident channel impulse response h_{inc}(t) or the backscatter channel impulse response h_{bck}(t)) may be sufficient to encompass the information of the N(N+1)/2 taps of the round-trip channel impulse response (e.g., the superposed channel impulse response hₛᵤₚ(t)), but with lower overhead.

In some aspects, as the reader device 1030 may only have information regarding the relationship between the received backscattered response signal (e.g., the second reference signal 1048) with respect to the transmitted interrogating signal (e.g., the first reference signal 1042), the reader device 1030 may have to first derive the round-trip channel impulse response (e.g., the superposed channel impulse response hₛᵤₚ(t)) anyway based on the first reference signal 1042 and the second reference signal 1048. In some aspects, the reader device 1030 may be capable and/or instructed to further process the round-trip channel impulse response to determine the one-way channel impulse response (e.g., the incident channel impulse response h_{inc}(t) or the backscatter channel impulse response h_{bck}(t)) in view of the equations illustrated above. Afterwards, the reader device 1030 may include the one-way channel impulse response (i.e., N taps) in a measurement report instead of the round-trip channel impulse response (i.e., N(N+1)/2 taps) in order to reduce the reporting overhead.

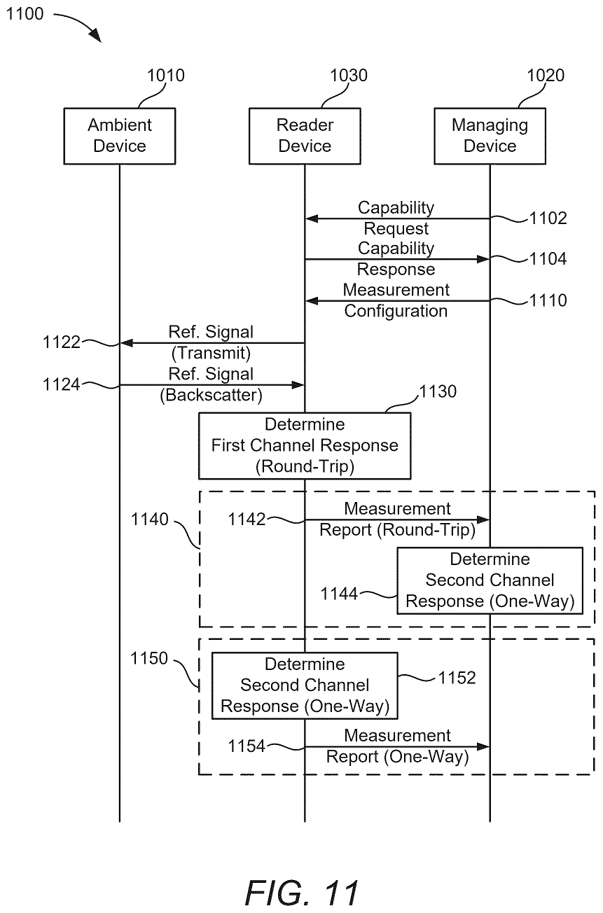

FIG. 11 is a procedure flow diagram 1100 showing example flows of providing a measurement report that include a reported channel impulse response, according to aspects of the disclosure. In some aspects, the procedure flow diagram 1100 may correspond to the scenario 1000 and may illustrate the interactions among the ambient device 1010, the reader device 1030, and the managing device 1020 as shown in FIG. 10A. As advanced above, in one example, the reader device 1030 may correspond to an intermediate node (such as any UE, or a relay, an IAB node, or a repeater), and the managing device 1020 may correspond to a base station (such as any of the base station or TRP described herein). Also, in another example, the reader device 1030 may correspond to a base station (such as any of the base station or TRP described herein), and the managing device 1020 may correspond to a location server (such as any of the location server, LMF, SLP, proprietary server, or any server described herein).

As shown in FIG. 11, at stage 1102, the managing device 1020 may send a capability request message to the reader device 1030. In some aspects, the capability request message may include a capability inquiry regarding whether the reader device 1030 is capable of determining a one-way channel impulse response based on a round-trip channel impulse response. As illustrated above, the one-way channel impulse response may correspond to either a first propagation channel from the reader device 1030 to the ambient device 1010 or a second propagation channel from the ambient device 1010 to the reader device 1030.

At stage 1104, the reader device 1030 may transmit a capability response to the managing device 1020 in response to the capability inquiry from stage 1102. In some aspects, the capability response may indicate whether the reader device 1030 is capable of (either based on hardware limitations, software limitations, hardware configurations, software configuration, and/or administrative configurations) determining a one-way channel impulse response based on a round-trip channel impulse response.

At stage 1110, the managing device 1020 may transmit a measurement configuration message to the reader device 1030. In some aspects, the measurement configuration message may indicate that a reported channel impulse response to be included in a measurement report may be a round-trip channel impulse response (e.g., with N(N+1)/2 taps) corresponding to the combination of the first propagation channel and the second propagation channel, or may be a one-way channel impulse response (e.g., with N taps) corresponding to either the first propagation channel or the second propagation channel. In some aspects, the managing device 1020 may determine whether the reader device 1030 should provide the round-trip channel impulse response or the one-way channel impulse response based on the capability response from stage 1104. In some aspects, the managing device 1020 may transmit the measurement configuration message without based on the capability response, and the stages 1102 and 1104 may be omitted.

In some aspects, the measurement configuration message may include configurations related to one or more ambient devices communicatively coupled with to the reader device 1030. In some aspects, the measurement configuration message may be a standalone message dedicated to providing measurement configurations related to the one or more ambient devices. In some aspects, the measurement configuration message may be part of a measurement configuration that includes information for configuring the measurements performed by the reader device 1030 itself.

At stage 1122, the reader device 1030 may transmit a first reference signal to the ambient device 1010. In some aspects, the first reference signal may be a PRS, an SRS, or a dedicated reference signal for a backscatter-based positioning procedure.

At stage 1124, the reader device 1030 may receive a second reference signal that is in response to the first reference signal. In some aspects, the second reference signal is a backscattered response signal transmitted by the ambient device 1010 based on backscattering the first reference signal from stage 1122. In some aspects, the first reference signal and the second reference signal may have a same operating frequency such that the channel reciprocity may apply.

At stage 1130, the reader device 1030 may determine a first channel impulse response based on the first reference signal and the second reference signal. In some aspects, the first channel impulse response may be the round-trip channel impulse response and may correspond to a combination of the first propagation channel from the reader device 1030 to the ambient device 1010 and the second propagation channel from the ambient device 1010 to the reader device 1030.

Afterwards, the reader device 1030 may generate a measurement report for output, where the measurement report may include a reported channel impulse response that is based on the first channel impulse response and indicates multiple propagation paths observable from the second reference signal. The procedure after stage 1130 may include two alternative approaches for preparing and reporting the measurement report as illustrated by block 1140 and block 1150.

At block 1140, if the reader device 1030 is not capable of deriving the one-way channel impulse response (i.e., a second channel impulse response) based on the round-trip channel impulse response (i.e., the first channel impulse response), or if the reader device 1030 is so instructed by the managing device 1020 according to the measurement configuration message from stage 1110, the measurement report may include the first channel impulse response as the reported channel impulse response. At stage 1142, the reader device 1030 may transmit the measurement report to the managing device 1020 reporting the round-trip channel impulse response. At stage 1144, the managing device 1020 may determine the one-way channel impulse response (i.e., the second channel impulse response) based on the round-trip channel impulse response (i.e., the first channel impulse response).

At block 1150, if the reader device 1030 is capable of deriving the one-way channel impulse response (i.e., the second channel impulse response) based on the round-trip channel impulse response (i.e., the first channel impulse response), or if the reader device 1030 is capable and so instructed by the managing device 1020 according to the measurement configuration message from stage 1110, the reader device 1030 may determine 1152 the one-way channel impulse response (i.e., the second channel impulse response) based on the round-trip channel impulse response (i.e., the first channel impulse response). The reader device 1030 may at stage 1154 transmit to the managing device 1020 the measurement report that may include the second channel impulse response as the reported channel impulse response.

In some aspects, the reported channel impulse response included in the measurement report may be reported based on a reporting format for reporting additional path information set forth in a communication standard. In some aspects, the reported channel impulse response included in the measurement report may be reported based on a newly designed (or a dedicated) reporting format different from the reporting format for reporting additional path information. In some aspects, each tap (or path) of the reported channel impulse response may be a complex number. In some aspects, the reported channel impulse response may be reported to include attributes such as, for each tap or path, a time value (e.g., indicating a time difference to an estimated LOS path), two tap values (e.g., indicting an amplitude and a phase, a gain or a phase, or a real part and an imaginary part, of each tap), or any subset of these attributes.

In some aspects, the measurement report may include an indicator indicating that the reported channel impulse response is the one-way impulse response corresponding to either the first propagation channel or the second propagation channel (e.g., the indicator having a value ‘1’), or is the round-trip channel impulse response corresponding to the combination of the first propagation channel and the second propagation channel (e.g., the indicator having a value ‘0’).

In some aspects, as illustrated above, the determining the second channel impulse response may be based on an equation of hₛᵤₚ(t)=h_{bck}(t)*h_{bck}(t), where hₛᵤₚ(t) may represent the first channel impulse response (e.g., the superposed channel impulse response), and h_{bck}(t) may represent the second channel impulse response (e.g., the backscatter channel impulse response). In some aspects, the second channel impulse response may be determined based on a deconvolution process. In some aspects, the deconvolution process may include a successive tap cancellation process.

In some aspects, the ambient device 1010 (and/or the reader device 1030) may cause some errors and mismatches added to the incident channel impulse response and the backscatter channel impulse response, such as adding a group delay or introducing some frequency selectivity. In some aspects under such scenario, the reader device 1030 may attempt to compensate the errors and mismatched when determining the one-way channel impulse response based on the round-trip channel impulse response.

For example, the determining the second channel impulse response may be based on an equation of hₛᵤₚ(t)=h_{bck}(t)*h_{bck}(t)+e t), where e(t) represents the estimated effects of a frequency shift, a delay, or both caused by the ambient device 1010. In some aspects, the reader device 1030 may determine the second channel impulse response (e.g., the backscatter channel impulse response) based on mathematically estimating, compensating, and minimizing the factor e(t).

In some aspects, the steps illustrated in the procedure flow diagram 1100 may be applicable to the reader device 1030 and the ambient device 1010 operating in a FDX mode as well as in a HDX mode. In some aspects, the reader device 1030 operating in the HDX mode may further report additional taps/paths and/or measurements at stage 1154 that are included in the round-trip channel impulse response but not considered or included as part of the one-way channel impulse response.

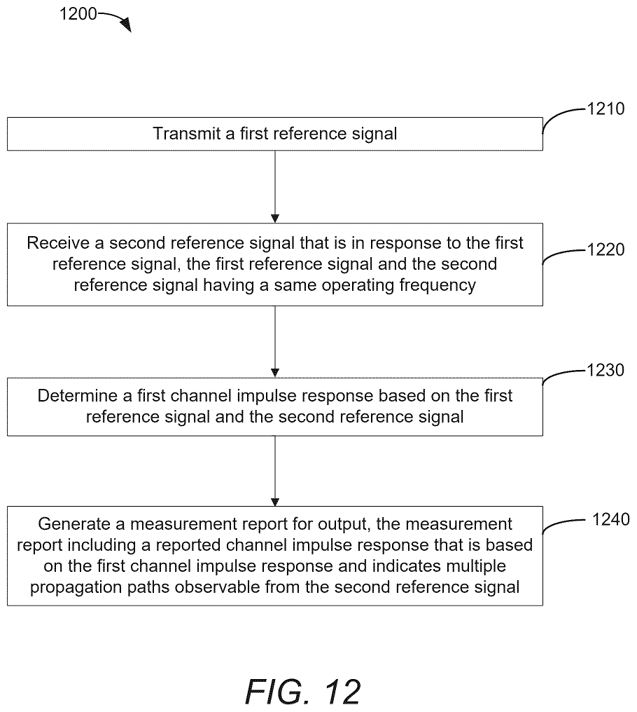

FIG. 12 is a flowchart illustrating a method 1200 of operating a wireless communication device, according to aspects of the disclosure. In some aspects, the wireless communication device in the method 1200 may correspond to the reader device 1030 in FIG. 10A and FIG. 11. In some aspects, the reader device 1030 may correspond to the base station 920 in FIG. 9A (such as any of the base station or TRP described herein); and the method 1200 may be performed by the one or more WWAN transceivers 450, the one or more network transceivers 480, the one or more processors 484, the memory 486, and/or the ambient component 488, any or all of which may be considered means for performing one or more of the following operations of method 1200. In some aspects, the reader device 1030 may correspond to the intermediate node 930 in FIG. 9B (such as any UE, or a relay, an IAB node, or a repeater); and the method 1200 may be performed by the one or more WWAN transceivers 410, the one or more processors 442, the memory 440, and/or the ambient component 448, any or all of which may be considered means for performing one or more of the following operations of method 1200.

At operation 1210, the wireless communication device (e.g., the reader device 1030) may transmit a first reference signal. In some aspects, operation 1210 may correspond to stage 1122 in FIG. 11. In some aspects, the first reference signal may be a PRS, an SRS, or a dedicated reference signal for a backscatter-based positioning procedure. In some aspects, operation 1210 may be performed by the one or more WWAN transceivers 450, the one or more processors 484, the memory 486, and/or the ambient component 488, any or all of which may be considered means for performing operation 1210. In some aspects, operation 1210 may be performed by the one or more WWAN transceivers 410, the one or more processors 442, the memory 440, and/or the ambient component 448, any or all of which may be considered means for performing operation 1210.

At operation 1220, the wireless communication device may receive a second reference signal that is in response to the first reference signal. In some aspects, the first reference signal and the second reference signal may have a same operating frequency. In some aspects, operation 1220 may correspond to stage 1124 in FIG. 11. In some aspects, the first reference signal may be transmitted to an ambient device (e.g., the ambient device 1010), and the second reference signal may be from the ambient device. In some aspects, the second reference signal may be a backscattered response signal transmitted by the ambient device 1010 based on backscattering the first reference signal. In some aspects, operation 1220 may be performed by the one or more WWAN transceivers 450, the one or more processors 484, the memory 486, and/or the ambient component 488, any or all of which may be considered means for performing operation 1220. In some aspects, operation 1220 may be performed by the one or more WWAN transceivers 410, the one or more processors 442, the memory 440, and/or the ambient component 448, any or all of which may be considered means for performing operation 1220.

At operation 1230, the wireless communication device may determine a first channel impulse response (e.g., the round-trip impulse channel impulse response or the superposed impulse channel impulse response illustrated above) based on the first reference signal and the second reference signal. In some aspects, operation 1230 may correspond to stage 1130 in FIG. 11. In some aspects, the first channel impulse response may correspond to a combination of a first propagation channel from the wireless communication device to the ambient device and a second propagation channel from the ambient device to the wireless communication device. In some aspects, operation 1230 may be performed by the one or more WWAN transceivers 450, the one or more processors 484, the memory 486, and/or the ambient component 488, any or all of which may be considered means for performing operation 1230. In some aspects, operation 1230 may be performed by the one or more WWAN transceivers 410, the one or more processors 442, the memory 440, and/or the ambient component 448, any or all of which may be considered means for performing operation 1230.

At operation 1240, the wireless communication device may generate a measurement report for output, the measurement report including a reported channel impulse response that is based on the first channel impulse response and indicates multiple propagation paths observable from the second reference signal. In some aspects, operation 1240 may correspond to block 1140 or block 1150 in FIG. 11. In some aspects, operation 1240 may be performed by the one or more WWAN transceivers 450, the one or more processors 484, the memory 486, and/or the ambient component 488, any or all of which may be considered means for performing operation 1240. In some aspects, operation 1240 may be performed by the one or more WWAN transceivers 410, the one or more processors 442, the memory 440, and/or the ambient component 448, any or all of which may be considered means for performing operation 1240.

In some aspects, as illustrated based on block 1140, the measurement report may include the first channel impulse response as the reported channel impulse response. In some aspects, the measurement report may include an indicator indicating that the reported channel impulse response is a round-trip channel impulse response that corresponds to the combination of the first propagation channel and the second propagation channel.

In some aspects, as illustrated based on block 1150, the method 1200 may further include determining a second channel impulse response based on the first channel impulse response, where the second channel impulse response may be a one-way channel impulse response that corresponds to either the first propagation channel or the second propagation channel. In some aspects, the measurement report includes the second channel impulse response as the reported channel impulse response. In some aspects, the measurement report includes an indicator indicating that the reported channel impulse response is the one-way channel impulse response that corresponds to either the first propagation channel or the second propagation channel.

In some aspects, the determining the second channel impulse response may be based on an equation of hₛᵤₚ(t)=h_{bck}(t)*h_{bck}(t), where hₛᵤₚ(t) represents the first channel impulse response, and h_{bck}(t) represents the second channel impulse response. In some aspects, the second channel impulse response may be determined based on a deconvolution process.

In some aspects, the determining the second channel impulse response may be based on an equation of hₛᵤₚ(t)=h_{bck}(t)*htxck (t)+c (t), where hₛᵤₚ(t) represents the first channel impulse response, h_{bck}(t) represents the second channel impulse response, and e(t) represents estimated effects of a frequency shift, a delay, or both caused by the ambient device.

In some aspects, the method 1200 may include receiving, from a managing device prior to the measurement report is transmitted, a measurement configuration message indicating that the reported channel impulse response included in the measurement report is (i) the round-trip channel impulse response that corresponds to the combination of the first propagation channel and the second propagation channel, or (ii) the one-way channel impulse response that corresponds to either the first propagation channel or the second propagation channel. In some aspects, the method 1200 may include transmitting the measurement report to the managing device based on the measurement configuration message.

In some aspects, the method 1200 may include receiving, from a managing device, a capability inquiry regarding whether the wireless communication device is capable of determining a second channel impulse response based on the first channel impulse response, where the second channel impulse response is a one-way channel impulse response that corresponds to either the first propagation channel or the second propagation channel. In some aspects, the method 1200 may include transmitting a capability response to the managing device in response to the capability inquiry.

As will be appreciated, a technical advantage of the method 1200 is allowing a wireless communication device (e.g., a reader device 1030) to report the additional path information regarding a propagation channel between the wireless communication device and an ambient device based on a one-way channel impulse response (e.g., having N taps) that is extracted from a round-trip channel impulse response (e.g., having N(N+1)/2 taps). Accordingly, comparing with reporting in a measurement report the round-trip channel impulse response, reporting the one-way channel impulse response may reduce the reporting overhead.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of operating a wireless communication device, the method comprising: transmitting a first reference signal; receiving a second reference signal that is in response to the first reference signal, the first reference signal and the second reference signal having a same operating frequency; determining a first channel impulse response based on the first reference signal and the second reference signal; and generating a measurement report for output, the measurement report including a reported channel impulse response that is based on the first channel impulse response and indicates multiple propagation paths observable from the second reference signal.

Clause 2. The method of clause 1, wherein: the first channel impulse response is a round-trip channel impulse response that corresponds to a combination of a first propagation channel from the wireless communication device to an ambient device and a second propagation channel from the ambient device to the wireless communication device.

Clause 3. The method of clause 2, wherein the measurement report includes the first channel impulse response as the reported channel impulse response.

Clause 4. The method of clause 3, wherein the measurement report includes an indicator indicating that the reported channel impulse response is the round-trip channel impulse response.

Clause 5. The method of clause 2, further comprising: determining a second channel impulse response based on the first channel impulse response, the second channel impulse response being a one-way channel impulse response that corresponds to either the first propagation channel or the second propagation channel, wherein the measurement report includes the second channel impulse response as the reported channel impulse response.

Clause 6. The method of clause 5, wherein the measurement report includes an indicator indicating that the reported channel impulse response is the one-way channel impulse response.

Clause 7. The method of any of clauses 5 to 6, wherein the determining the second channel impulse response is based on an equation of: hₛᵤₚ(t)=h_{bck}(t)*h_{bck}(t), wherein hₛᵤₚ(t) represents the first channel impulse response, and h_{bck}(t) represents the second channel impulse response.

Clause 8. The method of clause 7, wherein the second channel impulse response is determined based on a deconvolution process.

Clause 9. The method of any of clauses 5 to 6, wherein the determining the second channel impulse response is based on an equation of: hₛᵤₚ(t)=h_{bck}(t)*h_{bck}(t)+e(t), wherein hₛᵤₚ(t) represents the first channel impulse response, h_{bck}(t) represents the second channel impulse response, and e(t) represents estimated effects of a frequency shift, a delay, or both caused by the ambient device.

Clause 10. The method of any of clauses 2 to 9, further comprising: receiving, from a managing device prior to the measurement report is transmitted, a measurement configuration message indicating that the reported channel impulse response included in the measurement report is: the round-trip channel impulse response that corresponds to the combination of the first propagation channel and the second propagation channel, or a one-way channel impulse response that corresponds to either the first propagation channel or the second propagation channel; and transmitting the measurement report to the managing device based on the measurement configuration message.

Clause 11. The method of any of clauses 2 to 10, further comprising: receiving, from a managing device, a capability inquiry regarding whether the wireless communication device is capable of determining a second channel impulse response based on the first channel impulse response, the second channel impulse response being a one-way channel impulse response that corresponds to either the first propagation channel or the second propagation channel; and transmitting a capability response to the managing device in response to the capability inquiry.

Clause 12. The method of any of clauses 1 to 11, wherein: the first reference signal is transmitted to an ambient device, and the second reference signal is from the ambient device based on backscattering the first reference signal.

Clause 13. The method of any of clauses 1 to 12, wherein: the wireless communication device is an intermediate user equipment (UE) and is configured to transmit the measurement report to a base station, or the wireless communication device is a transmission-reception point (TRP) and is configured to transmit the measurement report to a location server.

Clause 14. A wireless communication device, comprising: one or more memories; one or more transceivers; and one or more processors communicatively coupled to the one or more memories and the one or more transceivers, the one or more processors, either alone or in combination, configured to: transmit, via the one or more transceivers, a first reference signal; receive, via the one or more transceivers, a second reference signal that is in response to the first reference signal, the first reference signal and the second reference signal having a same operating frequency; determine a first channel impulse response based on the first reference signal and the second reference signal; and generate a measurement report for output, the measurement report including a reported channel impulse response that is based on the first channel impulse response and indicates multiple propagation paths observable from the second reference signal.

Clause 15. The wireless communication device of clause 14, wherein: the first channel impulse response is a round-trip channel impulse response that corresponds to a combination of a first propagation channel from the wireless communication device to an ambient device and a second propagation channel from the ambient device to the wireless communication device.

Clause 16. The wireless communication device of clause 15, wherein the measurement report includes the first channel impulse response as the reported channel impulse response.

Clause 17. The wireless communication device of clause 16, wherein the measurement report includes an indicator indicating that the reported channel impulse response is the round-trip channel impulse response.

Clause 18. The wireless communication device of clause 15, wherein the one or more processors, either alone or in combination, are further configured to: determine a second channel impulse response based on the first channel impulse response, the second channel impulse response being a one-way channel impulse response that corresponds to either the first propagation channel or the second propagation channel, wherein the measurement report includes the second channel impulse response as the reported channel impulse response.

Clause 19. The wireless communication device of clause 18, wherein the measurement report includes an indicator indicating that the reported channel impulse response is the one-way channel impulse response.

Clause 20. The wireless communication device of any of clauses 18 to 19, wherein the second channel impulse response is determined based on an equation of: hₛᵤₚ(t)=h_{bck}(t)*h_{bck}(t), wherein hₛᵤₚ(t) represents the first channel impulse response, and h_{bck}(t) represents the second channel impulse response.

Clause 21. The wireless communication device of clause 20, wherein the second channel impulse response is determined based on a deconvolution process.

Clause 22. The wireless communication device of any of clauses 18 to 19, wherein the second channel impulse response is determined based on an equation of: hₛᵤₚ(t)=h_{bck}(t)*h_{bck}(t)+e(t), wherein hₛᵤₚ(t) represents the first channel impulse response, h_{bck}(t) represents the second channel impulse response, and e(t) represents estimated effects of a frequency shift, a delay, or both caused by the ambient device.

Clause 23. The wireless communication device of any of clauses 15 to 22, wherein the one or more processors, either alone or in combination, are further configured to: receive, via the one or more transceivers and from a managing device prior to the measurement report is transmitted, a measurement configuration message indicating that the reported channel impulse response included in the measurement report is: the round-trip channel impulse response that corresponds to the combination of the first propagation channel and the second propagation channel, or a one-way channel impulse response that corresponds to either the first propagation channel or the second propagation channel; and transmit, via the one or more transceivers, the measurement report to the managing device based on the measurement configuration message.

Clause 24. The wireless communication device of any of clauses 15 to 23, wherein the one or more processors, either alone or in combination, are further configured to: receive, via the one or more transceivers and from a managing device, a capability inquiry regarding whether the wireless communication device is capable of determining a second channel impulse response based on the first channel impulse response, the second channel impulse response being a one-way channel impulse response that corresponds to either the first propagation channel or the second propagation channel; and transmit, via the one or more transceivers, a capability response to the managing device in response to the capability inquiry.

Clause 25. The wireless communication device of any of clauses 14 to 24, wherein: the first reference signal is transmitted to an ambient device, and the second reference signal is from the ambient device based on backscattering the first reference signal.

Clause 26. The wireless communication device of any of clauses 14 to 25, wherein: the wireless communication device is an intermediate user equipment (UE) and is configured to transmit the measurement report to a base station, or the wireless communication device is a transmission-reception point (TRP) and is configured to transmit the measurement report to a location server.

Clause 27. A wireless communication device, comprising: means for transmitting a first reference signal; means for receiving a second reference signal that is in response to the first reference signal, the first reference signal and the second reference signal having a same operating frequency; means for determining a first channel impulse response based on the first reference signal and the second reference signal; and means for generating a measurement report for output, the measurement report including a reported channel impulse response that is based on the first channel impulse response and indicates multiple propagation paths observable from the second reference signal.

Clause 28. The wireless communication device of clause 27, wherein: the first channel impulse response is a round-trip channel impulse response that corresponds to a combination of a first propagation channel from the wireless communication device to an ambient device and a second propagation channel from the ambient device to the wireless communication device.

Clause 29. The wireless communication device of clause 28, wherein the measurement report includes the first channel impulse response as the reported channel impulse response.

Clause 30. The wireless communication device of clause 29, wherein the measurement report includes an indicator indicating that the reported channel impulse response is the round-trip channel impulse response.

Clause 31. The wireless communication device of clause 28, further comprising: means for determining a second channel impulse response based on the first channel impulse response, the second channel impulse response being a one-way channel impulse response that corresponds to either the first propagation channel or the second propagation channel, wherein the measurement report includes the second channel impulse response as the reported channel impulse response.

Clause 32. The wireless communication device of clause 31, wherein the measurement report includes an indicator indicating that the reported channel impulse response is the one-way channel impulse response.

Clause 33. The wireless communication device of any of clauses 31 to 32, wherein the second channel impulse response is determined based on an equation of: hₛᵤₚ(t)=h_{bck}(t)*h_{bck}(t), wherein hₛᵤₚ(t) represents the first channel impulse response, and h_{bck}(t) represents the second channel impulse response.

Clause 34. The wireless communication device of clause 33, wherein the second channel impulse response is determined based on a deconvolution process.

Clause 35. The wireless communication device of any of clauses 31 to 32, wherein the second channel impulse response is determined based on an equation of: hₛᵤₚ(t)=h_{bck}(t)*h_{bck}(t)+c (t), wherein hₛᵤₚ(t) represents the first channel impulse response, h_{bck}(t) represents the second channel impulse response, and e(t) represents estimated effects of a frequency shift, a delay, or both caused by the ambient device.

Clause 36. The wireless communication device of any of clauses 28 to 35, further comprising: means for receiving, from a managing device prior to the measurement report is transmitted, a measurement configuration message indicating that the reported channel impulse response included in the measurement report is: the round-trip channel impulse response that corresponds to the combination of the first propagation channel and the second propagation channel, or a one-way channel impulse response that corresponds to either the first propagation channel or the second propagation channel; and means for transmitting the measurement report to the managing device based on the measurement configuration message.

Clause 37. The wireless communication device of any of clauses 28 to 36, further comprising: means for receiving, from a managing device, a capability inquiry regarding whether the wireless communication device is capable of determining a second channel impulse response based on the first channel impulse response, the second channel impulse response being a one-way channel impulse response that corresponds to either the first propagation channel or the second propagation channel; and means for transmitting a capability response to the managing device in response to the capability inquiry.

Clause 38. The wireless communication device of any of clauses 27 to 37, wherein: the first reference signal is transmitted to an ambient device, and the second reference signal is from the ambient device based on backscattering the first reference signal.

Clause 39. The wireless communication device of any of clauses 27 to 38, wherein: the wireless communication device is an intermediate user equipment (UE) and is configured to transmit the measurement report to a base station, or the wireless communication device is a transmission-reception point (TRP) and is configured to transmit the measurement report to a location server.

Clause 40. A non-transitory computer-readable medium storing computer-executable instructions that, when executed by a wireless communication device, cause the wireless communication device to: transmit a first reference signal; receive a second reference signal that is in response to the first reference signal, the first reference signal and the second reference signal having a same operating frequency; determine a first channel impulse response based on the first reference signal and the second reference signal; and generate a measurement report for output, the measurement report including a reported channel impulse response that is based on the first channel impulse response and indicates multiple propagation paths observable from the second reference signal.

Clause 41. The non-transitory computer-readable medium of clause 40, wherein: the first channel impulse response is a round-trip channel impulse response that corresponds to a combination of a first propagation channel from the wireless communication device to an ambient device and a second propagation channel from the ambient device to the wireless communication device.

Clause 42. The non-transitory computer-readable medium of clause 41, wherein the measurement report includes the first channel impulse response as the reported channel impulse response.

Clause 43. The non-transitory computer-readable medium of clause 42, wherein the measurement report includes an indicator indicating that the reported channel impulse response is the round-trip channel impulse response.

Clause 44. The non-transitory computer-readable medium of clause 41, further comprising computer-executable instructions that, when executed by the wireless communication device, cause the wireless communication device to: determine a second channel impulse response based on the first channel impulse response, the second channel impulse response being a one-way channel impulse response that corresponds to either the first propagation channel or the second propagation channel, wherein the measurement report includes the second channel impulse response as the reported channel impulse response.

Clause 45. The non-transitory computer-readable medium of clause 44, wherein the measurement report includes an indicator indicating that the reported channel impulse response is the one-way channel impulse response.

Clause 46. The non-transitory computer-readable medium of any of clauses 44 to 45, wherein the second channel impulse response is determined based on an equation of: hₛᵤₚ(t)=h_{bck}(t)*h_{bck}(t), wherein hₛᵤₚ(t) represents the first channel impulse response, and h_{bck}(t) represents the second channel impulse response.

Clause 47. The non-transitory computer-readable medium of clause 46, wherein the second channel impulse response is determined based on a deconvolution process.

Clause 48. The non-transitory computer-readable medium of any of clauses 44 to 45, wherein the second channel impulse response is determined based on an equation of: hₛᵤₚ(t)=h_{bck}(t)*h_{bck}(t)+c (t), wherein hₛᵤₚ(t) represents the first channel impulse response, h_{bck}(t) represents the second channel impulse response, and e(t) represents estimated effects of a frequency shift, a delay, or both caused by the ambient device.

Clause 49. The non-transitory computer-readable medium of any of clauses 41 to 48, further comprising computer-executable instructions that, when executed by the wireless communication device, cause the wireless communication device to: receive, from a managing device prior to the measurement report is transmitted, a measurement configuration message indicating that the reported channel impulse response included in the measurement report is: the round-trip channel impulse response that corresponds to the combination of the first propagation channel and the second propagation channel, or a one-way channel impulse response that corresponds to either the first propagation channel or the second propagation channel; and transmit the measurement report to the managing device based on the measurement configuration message.

Clause 50. The non-transitory computer-readable medium of any of clauses 41 to 49, further comprising computer-executable instructions that, when executed by the wireless communication device, cause the wireless communication device to: receive, from a managing device, a capability inquiry regarding whether the wireless communication device is capable of determining a second channel impulse response based on the first channel impulse response, the second channel impulse response being a one-way channel impulse response that corresponds to either the first propagation channel or the second propagation channel; and transmit a capability response to the managing device in response to the capability inquiry.

Clause 51. The non-transitory computer-readable medium of any of clauses 40 to 50, wherein: the first reference signal is transmitted to an ambient device, and the second reference signal is from the ambient device based on backscattering the first reference signal.

Clause 52. The non-transitory computer-readable medium of any of clauses 40 to 51, wherein: the wireless communication device is an intermediate user equipment (UE) and is configured to transmit the measurement report to a base station, or the wireless communication device is a transmission-reception point (TRP) and is configured to transmit the measurement report to a location server.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of operating a wireless communication device, the method comprising:
transmitting a first reference signal;
receiving a second reference signal that is in response to the first reference signal, the first reference signal and the second reference signal having a same operating frequency;
determining a first channel impulse response based on the first reference signal and the second reference signal; and
generating a measurement report for output, the measurement report including a reported channel impulse response that is based on the first channel impulse response and indicates multiple propagation paths observable from the second reference signal.

2. The method of claim 1, wherein:
the first channel impulse response is a round-trip channel impulse response that corresponds to a combination of a first propagation channel from the wireless communication device to an ambient device and a second propagation channel from the ambient device to the wireless communication device.

3. The method of claim 2, wherein the measurement report includes the first channel impulse response as the reported channel impulse response.

4. The method of claim 3, wherein the measurement report includes an indicator indicating that the reported channel impulse response is the round-trip channel impulse response.

5. The method of claim 2, further comprising:
determining a second channel impulse response based on the first channel impulse response, the second channel impulse response being a one-way channel impulse response that corresponds to either the first propagation channel or the second propagation channel,
wherein the measurement report includes the second channel impulse response as the reported channel impulse response.

6. The method of claim 5, wherein the measurement report includes an indicator indicating that the reported channel impulse response is the one-way channel impulse response.

7. The method of claim 5, wherein the determining the second channel impulse response is based on an equation of:
$${h}_{sup} ( t ) = {h}_{bck} ( t ) * {h}_{bck} ( t ) ,$$
hₛᵤₚ(t) represents the first channel impulse response, and
h_{bck}(t) represents the second channel impulse response.

8. The method of claim 7, wherein the second channel impulse response is determined based on a deconvolution process.

9. The method of claim 5, wherein the determining the second channel impulse response is based on an equation of:
$${h}_{sup} ( t ) = {h}_{bck} ( t ) * {h}_{bck} ( t ) + e ( t ) ,$$
wherein
hₛᵤₚ(t) represents the first channel impulse response,
h_{bck}(t) represents the second channel impulse response, and
e(t) represents estimated effects of a frequency shift, a delay, or both caused by the ambient device.

10. The method of claim 2, further comprising:
receiving, from a managing device prior to the measurement report is transmitted, a measurement configuration message indicating that the reported channel impulse response included in the measurement report is:
the round-trip channel impulse response that corresponds to the combination of the first propagation channel and the second propagation channel, or
a one-way channel impulse response that corresponds to either the first propagation channel or the second propagation channel; and
transmitting the measurement report to the managing device based on the measurement configuration message.

11. The method of claim 2, further comprising:
receiving, from a managing device, a capability inquiry regarding whether the wireless communication device is capable of determining a second channel impulse response based on the first channel impulse response, the second channel impulse response being a one-way channel impulse response that corresponds to either the first propagation channel or the second propagation channel; and
transmitting a capability response to the managing device in response to the capability inquiry.

12. The method of claim 1, wherein:
the first reference signal is transmitted to an ambient device, and
the second reference signal is from the ambient device based on backscattering the first reference signal.

13. The method of claim 1, wherein:
the wireless communication device is an intermediate user equipment (UE) and is configured to transmit the measurement report to a base station, or
the wireless communication device is a transmission-reception point (TRP) and is configured to transmit the measurement report to a location server.

14. A wireless communication device, comprising:
one or more memories;
one or more transceivers; and
one or more processors communicatively coupled to the one or more memories and the one or more transceivers, the one or more processors, either alone or in combination, configured to:
transmit, via the one or more transceivers, a first reference signal;
receive, via the one or more transceivers, a second reference signal that is in response to the first reference signal, the first reference signal and the second reference signal having a same operating frequency;
determine a first channel impulse response based on the first reference signal and the second reference signal; and
generate a measurement report for output, the measurement report including a reported channel impulse response that is based on the first channel impulse response and indicates multiple propagation paths observable from the second reference signal.

15. The wireless communication device of claim 14, wherein:
the first channel impulse response is a round-trip channel impulse response that corresponds to a combination of a first propagation channel from the wireless communication device to an ambient device and a second propagation channel from the ambient device to the wireless communication device.

16. The wireless communication device of claim 15, wherein the measurement report includes the first channel impulse response as the reported channel impulse response.

17. The wireless communication device of claim 15, wherein the one or more processors, either alone or in combination, are further configured to:
determine a second channel impulse response based on the first channel impulse response, the second channel impulse response being a one-way channel impulse response that corresponds to either the first propagation channel or the second propagation channel,
wherein the measurement report includes the second channel impulse response as the reported channel impulse response.

18. A non-transitory computer-readable medium storing computer-executable instructions that, when executed by a wireless communication device, cause the wireless communication device to:
transmit a first reference signal;
receive a second reference signal that is in response to the first reference signal, the first reference signal and the second reference signal having a same operating frequency;
determine a first channel impulse response based on the first reference signal and the second reference signal; and
generate a measurement report for output, the measurement report including a reported channel impulse response that is based on the first channel impulse response and indicates multiple propagation paths observable from the second reference signal.

19. The non-transitory computer-readable medium of claim 18, wherein:
the first channel impulse response is a round-trip channel impulse response that corresponds to a combination of a first propagation channel from the wireless communication device to an ambient device and a second propagation channel from the ambient device to the wireless communication device.

20. The non-transitory computer-readable medium of claim 19, further comprising computer-executable instructions that, when executed by the wireless communication device, cause the wireless communication device to:
determine a second channel impulse response based on the first channel impulse response, the second channel impulse response being a one-way channel impulse response that corresponds to either the first propagation channel or the second propagation channel,
wherein the measurement report includes the second channel impulse response as the reported channel impulse response.
